(19) United States
(12) Patent Application Publication
(10) Pub. No.: US 2025/0345769 A1
(43) Pub. Date: Nov. 13, 2025

(54) SYSTEMS AND METHODS FOR CHEMICAL CATALYTIC PROCESSING

(71) Applicant: Lydian Labs, Inc., Cambridge, MA (US)

(72) Inventors: Branko Zugic, Cambridge, MA (US); Kurt Van Allsburg, Cambridge, MA (US); Zachary T. Modest, Cambridge, MA (US)

(73) Assignee: Lydian Labs, Inc., Cambridge, MA (US)

(21) Appl. No.: 19/118,941

(22) PCT Filed: Oct. 19, 2023
(86) PCT No.: PCT/US2023/035537

§ 371 Date: Apr. 7, 2025

Related U.S. Application Data
(60) Provisional application No. 63/380,187, filed on Oct. 19, 2022.

(51) Int. Cl. B01J 19/08

(52) U.S. Cl. CPC B01J 19/087; B01J 2219/00135; B01J 2219/00155; B01J 2219/0871; B01J 2219/0892

(57) ABSTRACT

Provided herein are systems and methods for chemical reactions involving heterogeneous catalysis.

### CROSS REFERENCE TO RELATED APPLICATIONS

This application claims the benefit of priority to U.S. Provisional Patent Application 63/380,187, filed Oct. 19, 2022; the entire contents of which are incorporated herein by reference.

### BACKGROUND

Many of the most important chemicals to the world economy are produced through heterogeneous catalysis. Reactions involving heterogeneous catalysis often require heat at the surface of the catalyst. However, the heat transfer efficiency between fluid phase reactants and catalysts is typically poor, leading to energy waste. Gases are particularly inefficient at heat transfer because of their low heat capacities. Additionally, many traditional catalysts are supported on metal oxide pellets, which themselves are thermally insulating materials.

Accordingly, there is a need for systems and methods for chemical reactions involving heterogeneous catalysis that provide improved heat transfer efficiency.

### SUMMARY OF THE INVENTION

In certain aspects, provided herein is a reactor unit comprising:
an insulating housing;
an inlet configured to receive a reaction fluid;
an outlet configured to output a product fluid; and
a catalytic member; wherein:
the catalytic member is thermally conductive and electrically conductive; and
the catalytic member is fixed in the reactor unit and electrically coupled to a pair of conductors.

In further aspects, provided herein is a reactor assembly comprising a plurality of the reactor units, wherein the catalytic member of each reactor unit is electrically isolated from catalytic members of adjacent reactor units.

In some aspects, provided herein are methods for catalyzing an endothermic chemical reaction comprising:
supplying a reaction mixture to a reactor unit comprising a catalytic member with a catalytic surface, wherein:
the catalytic member is thermally conductive and electrically conductive; and
the catalytic member is fixed in the reactor unit and electrically coupled to a pair of conductors; and
applying electrical power to the catalytic member through the pair of conductors, thereby heating the catalytic member to a catalytic temperature;
thereby producing a product mixture.

In further aspects, provided herein is a method for catalyzing a chemical reaction, the method comprising:
supplying a carbon source gas and a reduction gas to a reactor unit comprising a catalytic member with a catalytic surface, wherein:
the catalytic member is thermally conductive and electrically conductive; and
the catalytic member is fixed in the reactor unit and electrically coupled to a pair of conductors; and
applying electrical power to the catalytic member through the pair of conductors, thereby heating the catalytic member;
thereby producing a product mixture comprising a reduced carbon source gas.

### BRIEF DESCRIPTION OF THE DRAWINGS

FIG. 1 depicts a reactor unit according to certain embodiments described herein.

FIG. 2 depicts a reactor assembly in which the reactor units have a cylindrical shape according to certain embodiments described herein.

FIG. 3 depicts a reactor assembly in which the reactor units have an annular shape according to certain embodiments described herein.

FIG. 4 depicts a reactor assembly in which the reactor units have a rectangular prism shape according to certain embodiments described herein.

FIG. 5 is an exploded view of a catalytic module in a reactor configuration with other catalytic modules according to certain embodiments described herein.

FIGS. 6A-6C show an exemplary reactor unit. FIG. 6A is a view of an exemplary catalytic member welded to a pair of conductors being placed inside a quartz tube. FIG. 6B is another view of an exemplary catalytic member welded to a pair of conductors being placed inside a quartz tube. FIG. 6C shows a full view of the catalytic member inside a quartz tube and welded to conductors on each end.

FIGS. 7A-7C show an exemplary reactor unit adapted for use in a reverse water-gas shift reaction. FIG. 7A is a close-up view of the exemplary reactor unit fitted with graphite ferrules. FIG. 7B is a wider view of the reactor unit showing that the reactor unit has been fitted with adaptors to receive and output a gas. FIG. 7C is a full view showing, among other things, a DC power supply.

FIG. 8 shows the output of a residual gas analyzer, which monitored the gas phase at the outlet of a reactor during a reverse water-gas shift reaction.

FIG. 9 shows CO₂ conversion data for a reverse water-gas shift reaction conducted in the presence of metal foams of various compositions installed in a reactor tube in the configuration shown in FIGS. 6-7. Metal oxide-coated Ni foams with and without an active promoter (Al₂O₃ or Pt/CeO₂) are also shown.

FIGS. 10A and 10B show SEM images of Ni/Al₂O₃-coated SiC foams made by CVD deposition onto RVC.

FIGS. 11A and 11B show CH₄ and CO₂ conversion for dry methane reforming reaction over Ni/Al₂O₃ on SiC foam at a space velocity of 2500 h⁻¹.

FIG. 12 shows CO₂ conversion for the reverse water-gas shift reaction (CO₂+H₂ feed) over an exemplary Ni foam resistive element and Ni/Al₂O₃ on SiC foam at varying space velocities (GHSV).

FIG. 13 is a schematic drawing (side view) of a cylindrically shaped catalytic member having no coupling features.

FIGS. 14A and 14B are schematic drawings showing side (14A) and top (14B) views of an exemplary catalytic member (101) with concentrically oriented coupling features (102) at two ends of the catalytic member.

FIG. 15 is a schematic drawing of an exemplary catalytic member (101) with a negative coupling feature (102).

FIG. 16 shows a cross-sectional side view of an exemplary reactor assembly, with catalytic member (inner-most layer, 101), insulating housing (102), and pressure housing (outer-most layer, 103) concentrically arranged.

### DETAILED DESCRIPTION OF THE INVENTION

In certain aspects, provided herein are systems and methods for chemical reactions involving heterogeneous catalysis. The catalytic members described herein are electrically coupled to a pair of conductors in which the conductors are configured to apply electrical power to the catalytic member and thereby heat the surface of the catalytic member. Heating the surface of the catalytic member through the application of electric power from the pair of conductors provides improved heat transfer efficiency compared with relying on heat transfer from the fluid phase to the catalyst surface. As such, the systems and methods described herein are more energy efficient than other systems and methods for chemical reactions involving heterogeneous catalysis.

### Systems for Chemical Reactions Involving Heterogeneous Catalysis

In the present disclosure, certain components of the systems provided herein are described as being “coupled” to one another. As will be appreciated, the term “coupled” as used herein describes components that are operationally linked to one another, but does not preclude the presence of intervening components between those said to be coupled to one another.

Further, certain components provided herein are described as being “electrically coupled.” The term “electrically coupled” as used herein describes components having any connection allowing the transfer of electrical energy from one component to the other component. In certain embodiments, “electrically coupled” refers to a physical connection (e.g., electrical resistance welding, brazing, mechanical contacts, etc.) that enables the transfer of electrical energy from one component to the other component. In some embodiments, “electrically coupled” refers to a contactless connection (e.g., inductive coupling, capacitive coupling, power beaming, etc.) that enables the transfer of electrical energy from one component to the other component.

Additionally, as will be appreciated, various system components are described as “having” certain features. Such descriptions do not preclude, and specifically contemplate, the presence of additional features.

In certain aspects, provided herein is a reactor unit comprising:
an insulating housing;
an inlet configured to receive a reaction fluid;
an outlet configured to output a product fluid, e.g. a product fluid generated by a chemical reaction occurring in at least a portion of the reaction fluid; and
a catalytic member; wherein:
the catalytic member is thermally conductive and electrically conductive; and
the catalytic member is fixed in the reactor unit and electrically coupled to a pair of conductors configured to apply electrical power to the catalytic member.

In certain embodiments, the reactor unit further comprises a pressure-controlled housing surrounding the insulating housing. The pressure-controlled housing may be configured to control the pressure in the reactor unit.

Any suitable configuration of these features may be used, as will be apparent to those of skill in the art. Certain exemplary configurations are described herein. Additional configurations may be found in U.S. Provisional Application No. 63/524,468.

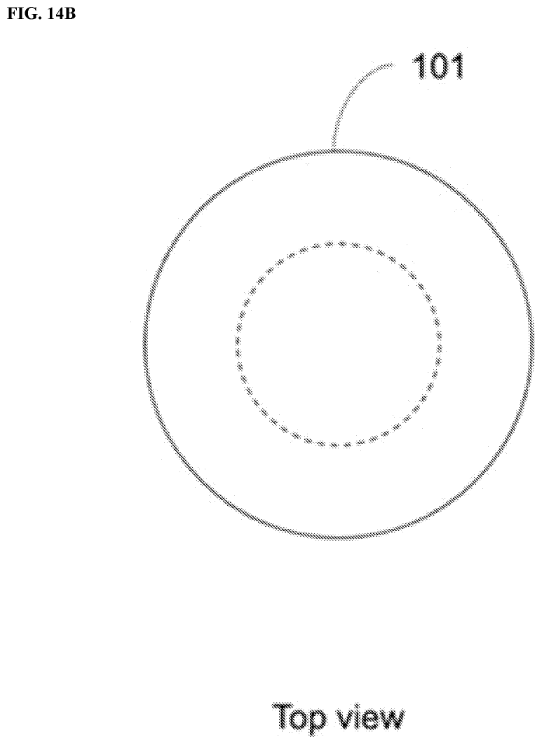

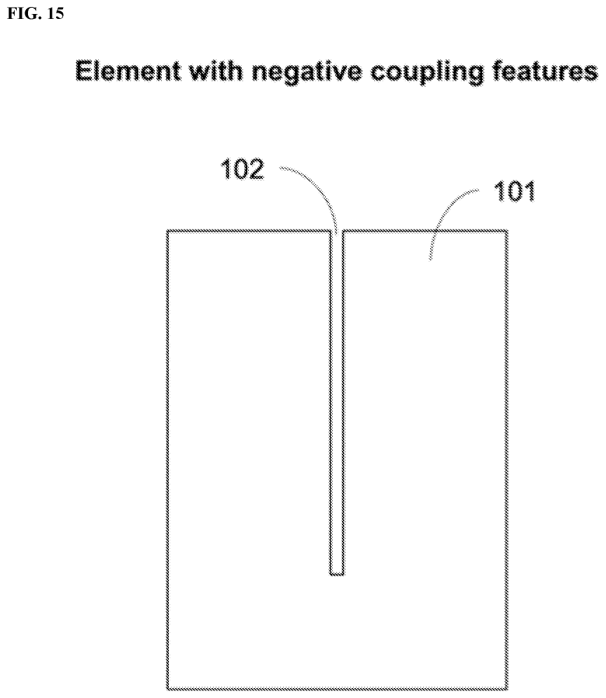

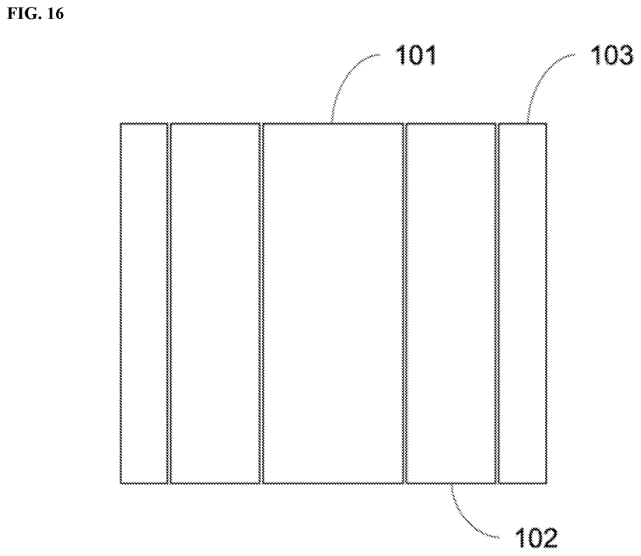

In certain embodiments, the catalytic member 101 is configured to be coupled to other system components (e.g., a pair of conductors). In some embodiments, the catalytic element 101 is coupled to a pair of conductors. In certain embodiments, the catalytic member 101 comprises one or more coupling features designed to enhance coupling to the other system components (e.g., FIGS. 14-16). In some embodiments, the coupling features may be concentric with the catalytic member 101 (FIGS. 14A, 14B). In other embodiments, the coupling features may be irregularly shaped to protrude from the catalytic member. In some embodiments the catalytic member is configured in a “net-shape” form, wherein the coupling features integrated into the catalytic member itself. In some embodiments, the coupling features are chemically, materially, or mechanically bound to the catalytic member. In certain embodiments, the coupling features may be from about 0.01% to about 50% of the total characteristic length of the element. In some embodiments, the coupling features may be created by the removal of a portion of the element, thereby forming indentations in the catalytic member (e.g., a “negative feature”). In some embodiments, the indentations are in the form of a slit (102, FIG. 15). The slit width may be between 0.01% to 90% of the characteristic length of the element. In some embodiments, the coupling features have a similar porosity to the remainder of the catalytic member. In other embodiments, the features have a porosity substantially lower than the remainder of the catalytic member. As described elsewhere herein, catalytic member 101 may be porous, such that gases can flow through the catalytic member. In some embodiments, the catalytic member, insulating housing, and pressure-controlled housing are in the form of concentrically arranged cylinders (FIG. 16). In other embodiments, as will be appreciated by one of skill in the art, the catalytic member, insulating housing, and pressure-controlled housing may be in the form of any suitable shape or arrangement compatible with the features and applications described elsewhere herein.

In certain embodiments, the catalytic member is configured to generate heat by the application of electrical power from the pair of conductors. In some embodiments, the catalytic member is configured to generate heat by at least one of resistive heating, inductive heating, dielectric heating, or frequency-based heating.

In certain embodiments, the catalytic member is electrically coupled to the pair of conductors by electrical resistance welding, brazing, chemical bonding, diffusion bonding, sintering, or mechanical contacts. In certain embodiments, a compatible material may be used to make a stable bond between the catalytic member and the pair of conductors, such as the application of pastes comprising Si, C, Ni, B, N, Zn, Zr, Al, Au, W, Co, and Ta, or a combination thereof. In some embodiments, one or both of the pair of conductors is centered in the catalytic member. In certain embodiments, conductors are located at opposite ends of the catalytic member. In certain embodiments, the contact surface area of each catalytic member-to-conductor bond may comprise between 1% and 50% of the geometric surface area of the catalytic member.

According to certain embodiments, the surface of the catalytic member comprises a catalyst.

In some embodiments, the product fluid is generated by a chemical reaction occurring in a portion of the reaction fluid, e.g., an endothermic chemical reaction. In some embodiments, the chemical reaction is a reverse water-gas shift reaction, a dry-methane reforming reaction, a thermochemical water splitting reaction, an alkane dehydrogenation reaction, a steam methane reforming reaction, a light hydrocarbon reforming reaction (e.g., “wet” or “dry” reformation), or a bi-reforming reaction. In certain preferred embodiments, the chemical reaction is a reverse water-gas shift reaction. In certain preferred embodiments, the chemical reaction is a dry methane reforming reaction.

In certain embodiments, the catalytic member is electrically coupled to the pair of conductors by electrical resistance welding, brazing, chemical bonding, diffusion bonding, sintering, or mechanical contacts.

In certain embodiments, the catalytic member has a length of from about 0.1 centimeters (cm) to about 2000 cm. In certain such embodiments, the catalytic member has a length from about 0.1 cm to about 1500 cm, about 0.1 cm to about 1000 cm, about 0.1 cm to about 500 cm, about 0.1 cm to about 250 cm, about 0.1 to about 100 cm, about 0.1 cm to about 50 cm, about 0.1 cm to about 40 cm, about 0.2 cm to about 30 cm, about 0.5 cm to about 20 cm, about 0.5 cm to about 10 cm, or about 1 cm to about 10 cm.

In certain embodiments, the catalytic member has an average ligament thickness of from about 0.005 micrometers (μm) to about 50 millimeters (mm), about 0.01 μm to about 40 mm, about 0.02 μm to about 20 mm, about 0.04 μm to about 20 mm, about 0.05 μm to about 20 mm, about 0.05 Lam to about 10 mm, about 0.1 lam to about 10 mm, about 0.2 μm to about 5 mm, about 0.4 μm to about 5 mm, about 0.5 μm to about 5 mm, about 0.5 μm to about 3 mm, about 0.5 μm to about 2 mm, about 1 μm to about 2 mm, about 1 μm to about 1 mm, about 10 μm to about 1 mm, or from about 10 μm to about 0.5 mm.

In certain embodiments, the catalytic member has a specific surface area of at least about 1 square centimeter per gram (cm²g⁻¹), at least about 5 cm²g⁻¹, at least about 10 cm²g⁻¹, at least about 50 cm²g⁻¹, at least about 100 cm²g⁻¹, at least about 500 cm²g⁻¹, at least about 10³ cm² g⁻¹, at least about 5×10³ cm² g⁻¹, at least about 10⁴ cm² g⁻¹, at least about 5×10⁴ cm² g⁻¹, at least about 10⁵ cm² g⁻¹, at least about 5×10⁵ cm² g⁻¹, or at least about 10⁶ cm² g⁻¹ In some embodiments, the catalytic member has a specific surface area of from about 1 square centimeter per gram (cm²g⁻¹) to about 10¹⁰ cm²g⁻¹, about 10 cm²g¹ to 10⁹ cm² g⁻¹ about 100 cm²g⁻¹ to 10⁸ cm²g⁻¹, about 10³ cm²g⁻¹ to 10⁸ cm²g⁻¹, about 10⁴ cm²g⁻¹ to 10⁸ cm²g⁻¹, about 10⁵ cm² g⁻¹ to 10⁸ cm² g⁻¹, or about 10⁵ cm² g⁻¹ to 10⁸ cm² g⁻¹.

In certain embodiments, the catalytic member has a porosity of at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the catalytic member has a porosity of from about 60% to about 99%, from about 65% to about 98%, from about 70% to about 98%, from about 75% to about 98%, from about 80% to about 98%, or from about 85% to about 95%.

In certain embodiments, the catalytic member has a thermal conductivity of at least about 1 watts per meter Kelvin (Wm⁻¹K⁻¹), at least about 10 Wm⁻¹K⁻¹, at least about 20 Wm⁻¹K⁻¹, at least about 40 Wm⁻¹K⁻¹, at least about 50 Wm⁻¹K⁻¹, at least about 75 Wm⁻¹K⁻¹, at least about 90 Wm⁻¹K⁻¹ at least about 100 Wm⁻¹K⁻¹, at least about 125 Wm⁻¹K⁻¹, at least about 150 Wm⁻¹K⁻¹, or at least about 175 Wm⁻¹K⁻¹.

In certain embodiments, the catalytic member has a thermal conductivity of less than about 5 watts per meter Kelvin (Wm⁻¹K⁻¹), less than about 10 Wm⁻¹K⁻¹, less than about 20 Wm⁻¹K⁻¹, less than about 40 Wm⁻¹K⁻¹, less than about 50 Wm⁻¹K⁻¹, less than about 75 Wm⁻¹K⁻¹, less than about 90 Wm⁻¹K⁻¹ less than about 100 Wm⁻¹K⁻¹, less than about 125 Wm⁻¹K⁻¹, less than about 150 Wm⁻¹K⁻¹, or less than about 175 Wm⁻¹K⁻¹.

In some embodiments, the catalytic member has a thermal conductivity of from about 1 watts per meter Kelvin (Wm⁻¹K⁻¹) to about 200 Wm⁻¹K⁻¹, from about 20 Wm⁻¹K⁻¹ to about 150 Wm⁻¹K⁻¹, or from about 50 Wm⁻¹K⁻¹ to about 120 Wm⁻¹K⁻¹.

In certain embodiments, the catalytic member has an electrical conductivity of less than about 10 Siemens per meter (Sm⁻¹), less than about 20 Sm⁻¹, less than about 50 Sm⁻¹, less than about 100 Sm⁻¹, less than about 200 Sm⁻¹, less than about 500 Sm⁻¹, less than about 10³ Sm⁻¹, less than about 2×10³ Sm⁻¹, less than about 5×10³ Sm⁻¹, less than about 10⁴ Sm⁻¹, less than about 2×10⁴ Sm⁻¹, less than about 5×10⁴ Sm⁻¹, less than about 10⁵ Sm⁻¹, less than about 2×10⁵Sm⁻¹, less than about 5×10⁵Sm⁻¹, less than about 10⁶ Sm⁻¹, less than about 2×10⁶Sm⁻¹, less than about 5×10⁶Sm⁻¹, less than about 7×10⁶Sm⁻¹, less than about 9×10⁶Sm⁻¹, less than about 10×10⁶Sm⁻¹, less than about 12×10⁶Sm⁻¹, or less than about 14×10⁶Sm⁻¹.

In certain embodiments, the catalytic member has an electrical conductivity of at least about 1 Siemens per meter (Sm⁻¹), at least about 20 Sm⁻¹, at least about 50 Sm⁻¹, at least about 100 Sm⁻¹, at least about 200 Sm⁻¹, at least about 500 Sm⁻¹, at least about 10³ Sm⁻¹, at least about 2×10³ Sm⁻¹, at least about 5×10³Sm⁻¹, at least about 10⁴ Sm⁻¹, at least about 2×10⁴ Sm⁻¹, at least about 5×10⁴ Sm⁻¹, at least about 10 Sm⁻¹, at least about 2×10⁵ Sm⁻¹, at least about 5×10⁵ Sm⁻¹, at least about 10⁶ Sm⁻¹, at least about 2×10⁶ Sm⁻¹, at least about 5×10⁶ Sm⁻¹, at least about 7×10⁶ Sm⁻¹, at least about 9×10⁶ Sm⁻¹, at least about 10×10⁶ Sm⁻¹, at least about 12×10⁶ Sm⁻¹ or at least about 14×10⁶ Sm⁻¹.

In some embodiments, the catalytic member has an electrical conductivity of from about 1 Siemens per meter (Sm⁻¹) to about 50 Sm⁻¹, In some embodiments, the catalytic member has an electrical conductivity of from about 10 Sm⁻¹ to about 10⁸ Sm⁻¹, from about 100 Sm⁻¹ to about 10⁸ Sm⁻¹, from about 10³ Sm⁴ to about 10⁸ Sm⁻¹, or from about 10³ Sm⁻¹ to about 10⁷ Sm⁻¹.

In certain embodiments, the catalytic member has an open-cell foam structure. In some embodiments, the catalytic member has a regular open-cell foam structure. According to one or more embodiments, the catalytic member has an irregular open-cell foam structure.

In certain embodiments, the catalytic member is a monolith comprising an array of parallel channels. The channels may be of any shape, such as rectangular, triangular, honeycomb-type structure, or any other cross-sectional shape. In certain embodiments, the channels may be interconnected via pores and/or additional channels. In other embodiments, the channels are not interconnected.

In certain embodiments, the catalytic member has a hierarchical structure. The hierarchical structure may be with respect to structure, pore size, composition, surface area, or active materials. In some embodiments, the hierarchical structure has at least two levels of pore sizes: large pores which act as mass transport “highways” that allow the reactants to diffuse to small pores and/or nanosized pores. In certain embodiments, the hierarchical structure comprises hierarchical layers of distinct phases or compositions (e.g., an underlying metallic substrate, and oxide layer, and deposited active metal species). In certain embodiments, each of the hierarchical layers comprises pores and ligaments progressively decreasing in size. In certain embodiments, the underlying metallic substrate has a high surface area, three-dimensional, porous structure of much smaller characteristic lengths. In some embodiments, the oxide layer is formed through the oxidization of alloys to promote a strong adherence of the coating. In certain embodiments, the oxide layer is a mixed metal oxide layer comprising a at least two metallic elements and oxygen. In some embodiments, the catalytic member comprises a conductive core structure, a protective ceramic layer conformally deposited on top of the core, an outer catalytically active layer composed of metal oxide(s) and/or at least one active catalytic phases. In certain such embodiments, the metal oxide(s) is(are) the active catalytic phase. In some embodiments, the oxide layer promotes strong adherence for a metal oxide coating.

In certain embodiments, a cross-sectional area of the largest pore of the catalytic member is greater than a cross-sectional area of the smallest pore of the catalytic member by a factor of less than about 100, less than about 50, less than about 20, less than about 15, less than about 10, less than about 7, less than about 5, less than about 3, less than about 2, less than about 1.5, less than about 1.2, or less than about 1.1. In some embodiments, a cross-sectional area of the largest pore of the catalytic member is greater than a cross-sectional area of the smallest pore of the catalytic member by a factor of at least about 1.2, at least about 1.5, at least about 2, at least about 5, at least about 10, at least about 20, at least about 50, at least about 100, at least about 500, or at least about 1,000.

In some embodiments, a cross-sectional area of the largest pore of the catalytic member is greater than a cross-sectional area of the smallest pore of the catalytic member by a factor of from about 1.05 to about 10,000, from about 1.05 to about 1,000, from about 1.05 to about 500, from about 1.05 to about 100, from about 1.05 to about 50, from about 1.05 to about 10, from about 1.05 to about 5, from about 1.05 to about 3, or from about 1.05 to about 1.2.

In some embodiments, the catalytic member comprises a conductive metal selected from Ni, Al, Cu, Au, Ag, Mo, Mn, V, Fe, Co, Cr, Pt, Pd, C, In, Ta, Ti, W, Sn, In, Zn, or a combination thereof. In certain embodiments, the catalytic member comprises a conductive metal selected from Ni, Al, Cu, Au, Ag, Mo, Mn, V, Fe, Co, Cr, Pt, Pd, La, Ce, Ba, C, In, Ta, Ti, W, Ru, Rh, Ir, Sn, In, Hf, Nd, Y and Zn, or a combination thereof. In certain preferred embodiments, the catalytic member comprises Ni. In some preferred embodiments, the catalytic member consists essentially of a metal selected from Ni, Al, Cu, Au, Ag, Mo, Mn, V, Fe, Co, Cr, Pt, Pd, C, In, Ta, Ti, W, Sn, In, and Zn, or a combination thereof. In some preferred embodiments, the catalytic member consists essentially of a conductive metal selected from Ni, Al, Cu, Au, Ag, Mo, Mn, V, Fe, Co, Cr, Pt, Pd, La, Ce, Ba, C, In, Ta, Ti, W, Ru, Ir, Rh, Sn, In, Hf, Nd, Y and Zn, or a combination thereof. In certain preferred embodiments, the catalytic member consists essentially of Ni.

In certain embodiments, the catalytic member comprises a conductive ceramic. As will be appreciated by one of skill in the art, any suitable ceramic with a suitable resistivity may be used in the systems and methods provided herein. The particular embodiments set forth below are provided both to exemplify such ceramics and to identify ceramics particularly well-suited for use in conjunction with the other features of the systems and methods disclosed herein. In some preferred embodiments, the ceramic is SiC. In some embodiments, the catalytic member comprises an electrically conductive bulk that consists essentially of a conductive ceramic, and further comprises a catalytic surface, e.g., a suitable catalytic coating as exemplified herein. In certain embodiments, the ceramic consists essentially of SiC. In certain embodiments, the ceramic comprises a dopant. In certain preferred embodiments, the dopant modifies the resistivity of the ceramic. In certain embodiments, the dopant is selected from C, Ni, W, B, Si, Mo, V, Ta, Ti, Co, Zr, and N, or a combination thereof. In certain preferred embodiments, the ceramic is SiC and the dopant comprises free carbon or silicon, MoSi₂, and/or controlled amounts of beta-SiC in combination with alpha-SiC.

In certain embodiments, the conductive ceramic comprises an active metal catalyst disposed directly on the conductive ceramic. In some such embodiments, the active metal catalyst is a layer disposed on the surface of the conductive ceramic. In certain embodiments, the active metal catalyst is disposed on the surface of the conductive ceramic in the form of particles. In other embodiments, the catalytic member comprises one or more layers of a metal oxide (or a mixed metal oxide) disposed on the outer surface of the ceramic, and the catalytic member further comprises an active metal catalyst layer disposed on the outermost surface of the metal oxide or mixed metal oxide layer(s).

In certain embodiments, the catalytic member comprises a ceramic-metallic composite (e.g., a CerMet material) comprising a ceramic component and a metallic component. In some such embodiments, the ceramic component of the ceramic-metallic composite is a conductive ceramic as described herein, and the metallic component of the ceramic-metallic composite is a conductive metal as described herein. In preferred embodiments, the catalytic member comprises an active metal catalyst disposed directly on the ceramic-metallic composite. In some such embodiments, the active metal catalyst is a layer disposed on the surface of the ceramic-metallic composite. In certain embodiments, the active metal catalyst is disposed on the surface of the ceramic-metallic composite in the form of particles (e.g., nanoparticles). In other embodiments, the catalytic member comprises one or more layers of a metal oxide (or a mixed metal oxide) disposed on the outer surface of the ceramic-metallic composite, and the catalytic member further comprises an active metal catalyst layer disposed on the outermost surface of the metal oxide or mixed metal oxide layer(s).

In certain embodiments, the catalytic member has a macrostructure in the shape of a cylinder, rectangular prism, sphere, annular cylinder, helix, or a combination thereof. In certain preferred embodiments, the catalytic member has a macrostructure in the shape of a helix. In some embodiments, the macroscopic shape of the catalytic member is designed to maximize heat transfer and interaction with the reaction fluid.

### Fabrication of the Catalytic Member

The catalytic members described herein may be fabricated using any suitable technique.

In some embodiments, for catalytic members comprising a ceramic (preferably wherein the ceramic is a carbide or doped carbide-based material) with a 3-dimensional open cell structure, the 3-dimensional open cell structure may be derived from a polymer template.

In certain embodiments, a precursor resin (e.g. phenolic resin) is used to impregnate a polyurethane open-cell foam, thereby forming an impregnated polyurethane open-cell foam. The impregnated polyurethane open-cell foam is pyrolyzed in an inert atmosphere to generate a reticulated vitreous carbon. In certain such embodiments, ceramic precursors (e.g., Si, Zr, and/or Ti) can then be deposited, e.g., by Chemical Vapor Deposition (CVD) to yield a carbide-based ceramic material. In other embodiments, the polyurethane foam is used as a template to host a pre-ceramic slurry (e.g., SiC, binders, phenolic resin, wax, or other graphite precursors) via a slip-casting process, thereby forming a coated foam. In certain such embodiments, the coated foams are pyrolyzed and further reacted with free metal or metalloid precursors (e.g., molten silicon) to convert the coated foam into a carbide ceramic.

In certain embodiments, a polymer or other mold may be prepared, e.g., by 3D printing, into which a pre-ceramic slurry comprising ceramic particles, binder, and wax is deposited and allowed to cure. In some such embodiments, the mold is then removed by dissolution, oxidation, decomposition, or other suitable methods. In further such embodiments, the resulting 3-dimensional pre-ceramic is sintered and/or doped to form a rigid, conductive ceramic.

In some embodiments, the ceramic material may be further treated. In certain such embodiments, the ceramic material is further treated by oxidation in an oxidation gas selected from air, oxygen, ozone, a combination thereof, or another suitable oxidizing environment, including e.g., chemical oxidation in solution. This further treatment makes the surface more hydrophilic and provides improved adhesion of oxide-based catalytic materials that may be applied to the surface by, e.g., wash-coating.

In certain embodiments, the ceramic element is 3D-printed from a pre-ceramic polymer resin or using binderjet printing in which the ceramic is deposited with the use of a binder prior to sintering at high temperature. In alternative embodiments, a ceramic slurry may be deposited using an extrusion process.

In some embodiments, the catalytic member is formed by plating of a polymer template, casting, 3D printing, or foaming of melted (i.e., molten) metal. In certain such embodiments, the catalytic member is formed by plating of a polymer template, and the template is prepared by foaming of a polymer melt using physical or chemical agents, 3D printing, or other foaming process. In further such embodiments, the polymer templates may be treated to activate the surface for metal deposition. In certain embodiments, metals such as nickel, iron, cobalt, copper, gold, silver, aluminum and alloys thereof are then deposited via electroless deposition to a thickness from about 0.01 to about 1000 micrometers. In some embodiments, metals are deposited on the template by vapor deposition techniques, such as chemical vapor deposition (CVD) and physical vapor deposition (PVD). In certain embodiments, one or more additional components are deposited on the substrate. In further embodiments, the one or more additional components are deposited on the substrate via electroplating or galvanic exchange. In certain embodiments, the polymer template is then removed by decomposition or oxidation at high temperature.

In some embodiments in which the catalytic member is formed by casting, a wax or polymer based model may be used to fabricate a mold from a plaster or other sufficiently temperature-resistant material. The wax or polymer may then be removed from the mold by melting or decomposition. A melt of the desired metal composition may then be poured into the mold to create a 3-dimensional structure of desired macroscopic properties. The melt may contain metal oxide powders to stabilize the structure and provide catalytically active additives or support materials. In some embodiments, an open-cell polymer foam or other polymeric structure may be used to fabricate a mold by filling the pores with a slurry of a heat resistant material. This investment mold is then similarly used to fabricate a metallic foam. Pressure (or vacuum) and temperature may be used to improve infiltration of the investment mold by the molten metal mixture.

In certain embodiments, the catalytic member is formed by casting of composite materials. Casting of metals and metal alloys in around spacers and other components may be used to generate porosity and more complex compositions in molded elements. Spheres, granules, and other particulates composed of metal oxides, carbides, salts, and/or polymers can be packed inside a larger mold. Molten metal or metal alloys may then be poured into the interstitial spacing. Vacuum or pressure may be used to fill the interstitial space entirely. Polymers and metal oxides can then be removed by thermal treatment or leaching in acid or base. The final composition of the melt may include some of the metal oxide components to promote structural integrity and catalytic activity. Alternatively, the spheres, granules, and/or other particulates may be pressed into a mold with a powdered metal or metal alloy precursor.

A binder may be used to adhere the metal powder to the spheres, granules, and/or particulates. Increasing the temperature results in sintering and/or melting of the metal or metal alloy powder, resulting in a porous foam structure. The space filling spheres, granules, and/or particulates can then be removed by thermal or acid/base treatment.

In certain embodiments, the catalytic member is formed by foaming of a melted metal, and the catalytic member is formed by (a) injecting an inorganic or organic gas through a melt of desired composition, wherein the melt may be stabilized by the addition of metal oxide or ceramic particles in the size range of 0.1 to 20 microns in quantities up to 25 wt %; (b) addition of a blowing agent to the melt, the blowing agent (e.g., TiH₂ or carbonates) designed to decompose above the melting temperature of the parent melt, releasing a gas (e.g., hydrogen) which contributes the void space of the resulting foam; (c) dissolution of hydrogen into the melt at high pressure, followed by lowering the pressure and cooling the melt below the melting temperature; or (d) compaction and processing (e.g. rolling, cutting, roll bonding/cladding) of metal powder precursors and blowing agents into desired form factors, followed by temperature treatment (optionally loaded into a mold, or injected into a mold once melted) to create porosity.

In some embodiments, the catalytic member is formed by direct 3D printing, and the catalytic member is formed by direct extrusion of a metal or metal alloy directly, selective laser melting or sintering of a metal or metal alloy powder precursor in a printing bed, direct ink writing, or binder jetting.

In certain embodiments, the catalytic member is further processed by free corrosion, electrochemical dealloying, or oxidation. In embodiments in which the catalytic member comprises a metal alloy, the catalytic member may be further processed by dealloying one of the metal components using free corrosion (in acid or base), electrochemical dealloying, oxidation, or other such modification technique. This may be used to modify electrical properties, increase surface area, and modify the surface composition. In some embodiments, additional catalytically active components may be added (with or without the dealloying step) by electroplating, galvanic exchange, impregnation, or other catalyst precursor or nanoparticle deposition methods.

In some embodiments, the catalytic member is further processed by wash-coating. In certain embodiments, the catalytic member is dipped in a slurry of metal oxide or catalyst materials. In certain embodiments, further processing may be performed using an external supply of heat (e.g. in an environmentally controlled furnace) or in-situ by resistively heating the member while subjecting it to the appropriate gas composition.

In certain embodiments, the catalytic member is further processed by thermal spraying. Thermal spraying (e.g. atmospheric plasma spraying, wire flame spraying) of metals and alloys can be used to deposit a low contact resistance coating on metal foams in order to improve structural integrity, provide current distribution contacts, and provide an enclosure for gas flow.

The resulting composition and porosity may contribute to the resistivity of the catalytic member, which may be tuned to efficiently take advantage of the power input in order to provide adequate heat to the reactor system. In some embodiments, the catalytic member may be further modified to stabilize the structure and modify the activity of the material through the deposition of catalytically active components (metals or metal oxides) by a variety of techniques including incipient wetness impregnation, physical vapor deposition, chemical vapor deposition, atomic layer deposition, galvanic exchange, electroplating, dip coating, oxidation and reduction processes (e.g., electrostatic absorption, grafting), etc.

In some embodiments, atomically-dispersed catalyst geometries may be employed to prevent coking and unwanted side reactions. Atomic dispersion can be achieved by depositing a small amount of catalyst precursor to a metal oxide support by any number of methods (e.g. impregnation, strong electrostatic adsorption). Alternatively, atomic dispersion can be achieved by using a bimetallic catalyst design in which the highly active component is dispersed in a host metal substrate; the host metal substrate can either be a nanoparticle or the high surface area metal foam substrate itself.

In certain embodiments, the above design considerations allow for control of the catalyst composition, which may be customized to the desired reaction in some embodiments; resistivity, which determines the electrical input required to heat the catalytic member in some embodiments; macro-scale structure, which allows the shape to be optimized for high reaction conversions in some embodiments; or any combination thereof.

In some embodiments, the catalytic member comprises a support material and a catalytic material, which may both be formed by the methods described above. According to one or more embodiments, the catalytic member further comprises a ceramic coated onto the support material. In some embodiments, the ceramic is SiC. In certain embodiments, the support material comprises an oxide or carbide of a metal selected from Al, Cr, Fe, Co, Na, K, Mg, Ca, Mn, Mo, V, Sn, Si, La, Pr, Ce, Zn, or a combination thereof. In certain embodiments, the support material comprises an oxide or carbide of a metal selected from Al, Cr, Fe, Co, Na, K, Mg, Ca, Mn, Mo, V, Sn, Si, La, Pr, Ce, Zn, Ti, Zr, and Ba, or a combination thereof. In some embodiments, the catalytic material comprises a metal chosen from Ni, Al, Cu, Au, Ag, Mo, Mn, V, Fe, Co, Cr, Pt, Pd, C, In, Ta, Ti, W, Sn, In, and Zn, or a combination thereof. In some embodiments, the catalytic material comprises a metal chosen from Ni, Al, Cu, Au, Ag, Mo, Mn, V, Fe, Co, Cr, Pt, Pd, La, Ce, Ba, C, In, Ta, Ti, W, Ru, Rh, Ir, Sn, In, Hf, Nd, Y and Zn, or a combination thereof. In certain embodiments, the catalytic material is deposited on the surface of the support material. In some embodiments, the catalytic material is deposited on the support material by dip coating, corrosion, electroplating, electrostatic adsorption, electrooxidation, electroreduction, galvanic exchange, wetness impregnation, or deposition precipitation. In certain embodiments, the catalytic material is intermixed with the support material.

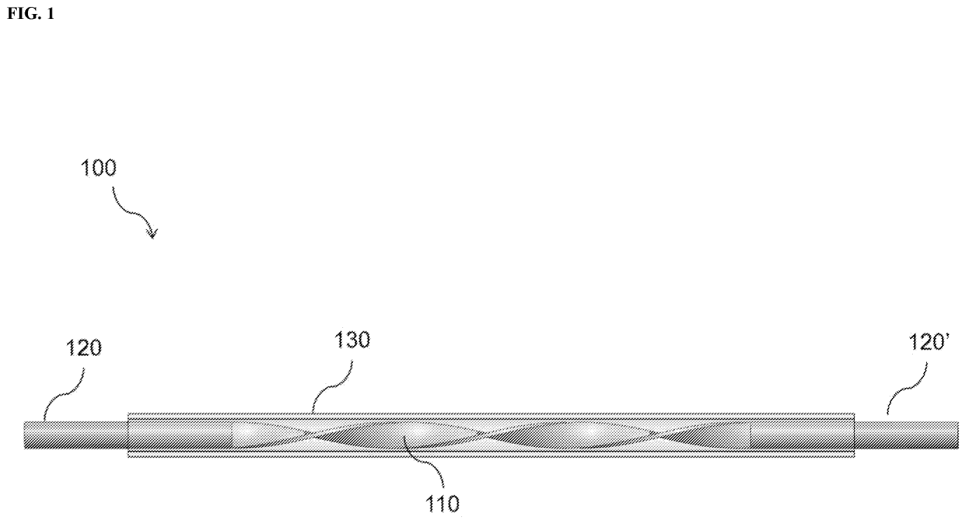

According to one or more embodiments depicted in FIG. 1, the reactor unit 100 comprises the catalytic member 110 having a helical shape welded to electrodes 120 and 120′. The insulating housing 130 surrounds the catalytic member. The helical shape of the catalytic member of FIG. 1 may promote mixing and facilitate contact between the surface of the catalytic member and the reactants.

In some embodiments, a reactor assembly comprising a plurality of the reactor units is provided, wherein the catalytic member of each reactor unit is electrically isolated from catalytic members of adjacent reactor units.

In certain embodiments, the housings of the reactor units of the reactor assembly are in the shape of a cylinder, a cone, or a rectangular prism.

In some embodiments, at least some of the catalytic members of the reactor units are configured to be operated at a different temperature than the catalytic members of other reactor units.

In certain embodiments, the reactor units are connected in series. In some embodiments, each of the reactor units are fluidly coupled to at least one other reactor unit of the reactor assembly.

In certain embodiments, the reactor units are arranged in parallel such that the inlets of each reactor unit are fluidically coupled.

In some embodiments, the reactor units are arranged concentrically.

In certain embodiments, each reactor unit is attached to a separate pair of conductors.

In some embodiments, each conductor, or pair of conductors, of each reactor unit applies power to the catalytic member independent of the power applied to other catalytic members.

In certain embodiments, each reactor unit is configured to host the same chemical reaction as the other reactor units.

In some embodiments, each of the reactor units are separated from adjacent reactor units via a spacer comprising an insulating material. In certain embodiments, the insulating material is ceramic, glass, rubber, or plastic. According to one or more embodiments, the insulating material is ceramic.

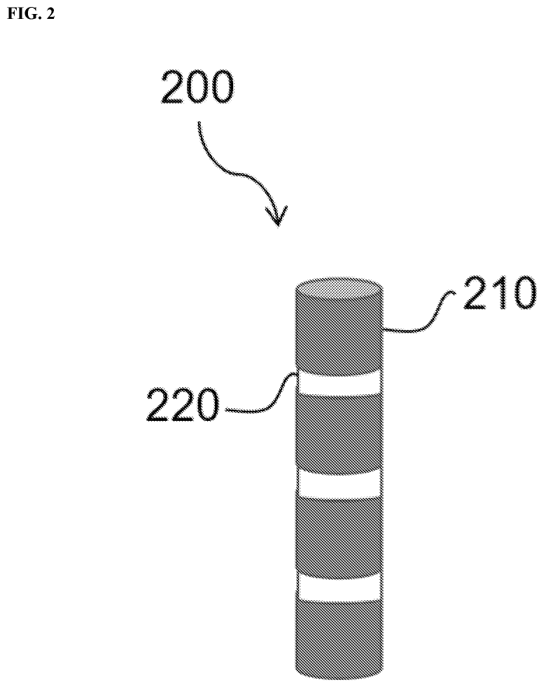

Some embodiments of the reactor assembly are depicted in FIG. 2. The reactor assembly 200 comprises reactor units 210 having a cylindrical shape and separated by spacers 220.

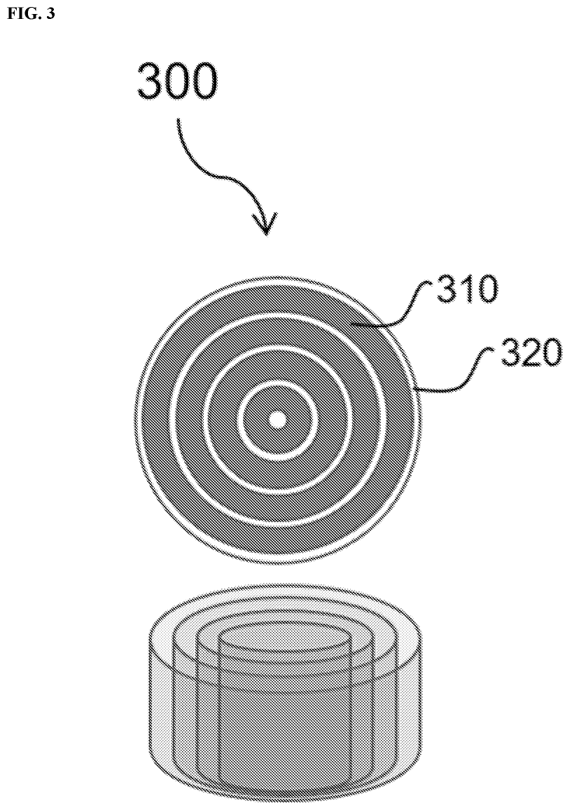

Certain embodiments of the reactor assembly are depicted in FIG. 3. The reactor assembly 300 comprises reactor units 310 having an annular shape arranged concentrically and separated by spacers 320.

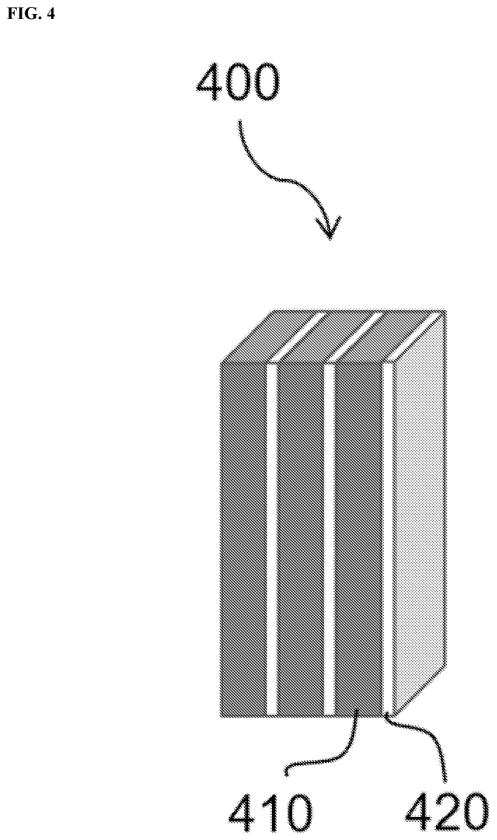

Some embodiments of the reactor assembly are depicted in FIG. 4. The reactor assembly 400 comprises reactor units 410 having a rectangular prism shape and separated by spacers 420.

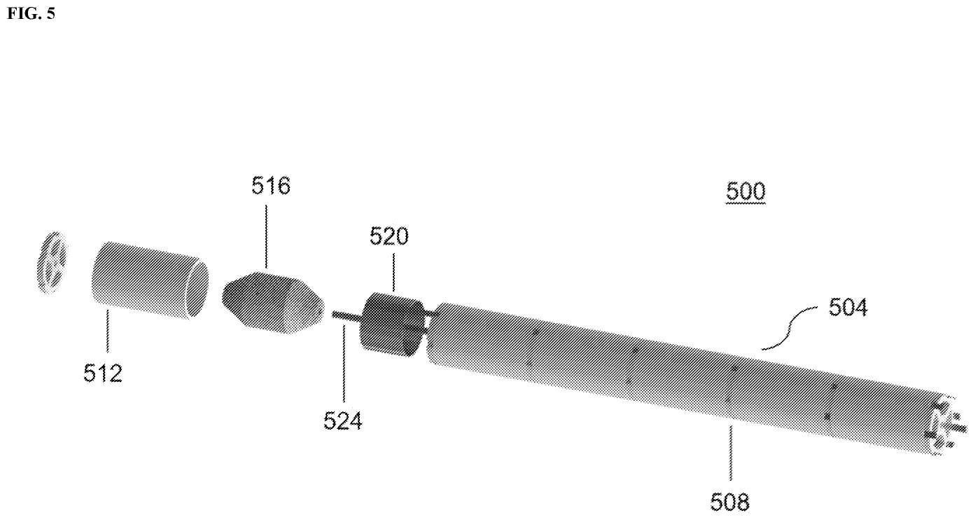

Certain embodiments of the reactor assembly are depicted in FIG. 5. The reactor assembly 500 comprises a plurality of reactor units 504 separated by ceramic spacers 508. Each reactor unit 504 comprises a ceramic housing 512 and contains a catalytic member 516, a connector ring 520 containing embedded conductors, and a central conductor 524. In one or more embodiments, the connector ring 520 enables electrical power to be applied individually to the catalytic member 516 while conductor 524 provides an electrical ground completing the circuit. Thus, each reactor unit 504 of the reactor assembly 500 may be heated individually. Connected end-to-end, the reactor units 504 of the reactor assembly 500 may form a pathway for multi-step processes.

### Methods for Chemical Reactions Involving Heterogeneous Catalysis

In certain aspects, provided herein is a method for catalyzing an endothermic chemical reaction comprising:
supplying a reaction mixture to a reactor unit comprising a catalytic member with a catalytic surface, wherein:
the catalytic member is thermally conductive and electrically conductive; and
the catalytic member is fixed in the reactor unit and electrically coupled to a pair of conductors; and
applying electrical power to the catalytic member through the pair of conductors, thereby heating the catalytic member to a catalytic temperature;
thereby producing a product mixture.

In certain embodiments, the reaction mixture comprises a carbon source gas (e.g., CO₂ or CO) and a reduction gas (e.g., H₂). In certain embodiments, the reaction mixture comprises a carbon source gas (e.g., methane) and an oxidation gas (e.g., CO₂ or H₂O).

In certain embodiments, the oxidation gas is CO₂. In certain embodiments, the oxidation gas is H₂O_{(g)}. In some preferred embodiments, the carbon source gas is a hydrocarbon, such as CH₄, ethane, propane, or butane. In further preferred embodiments, the hydrocarbon is CH₄. In certain such embodiments, the CH₄ is a component of a gas mixture that also comprises other hydrocarbons, such as ethane, propane, or butane. For example, the gas mixture used to supply CH₄ may be (or may be derived from) flare gas, waste gas, natural gas, or the like. In certain preferred embodiments, the carbon source gas is a C₁-C₃ hydrocarbon, or a combination thereof, and the oxidant gas is CO₂. In other preferred embodiments, the carbon source gas is a C₁-C₃ hydrocarbon, or a combination thereof, and the oxidant gas is H₂O_{(g)}.

In some preferred embodiments, the endothermic chemical reaction is wet or dry hydrocarbon reformation (e.g., light gas reformation, medium gas reformation, or gas reformation). In certain preferred embodiments, the endothermic chemical reaction is wet methane reformation. In certain preferred embodiments, the endothermic chemical reaction is dry methane reformation.

In certain aspects, provided herein is a method for catalyzing a chemical reaction, the method comprising:
supplying a carbon source gas and a reduction gas to a reactor unit comprising a catalytic member with a catalytic surface, wherein:
the catalytic member is thermally conductive and electrically conductive; and
the catalytic member is fixed in the reactor unit and electrically coupled to a pair of conductors; and
applying electrical power to the catalytic member through the pair of conductors, thereby heating the catalytic member to a catalytic temperature;
thereby producing a product mixture comprising a reduced carbon source gas.

As will be understood by one of ordinary skill in the art, a gas or mixture of gases suitable to be a carbon source gas in certain embodiments may also be a suitable reduction gas in the same or other embodiments of the disclosure, and vice versa. For example, in certain embodiments, methane may be a carbon source gas (e.g., in combination with CO₂ in a dry methane reformation process), and in the same or other embodiments, methane may be a reduction gas (e.g., in combination with CO₂ in a dry methane reformation process).

In certain embodiments, the carbon source gas is CO₂.

In some embodiments, the reduction gas is H₂.

In certain preferred embodiments, the carbon source gas is CO₂ and the reduction gas is H₂.

In some embodiments, the reductant gas is a hydrocarbon, such as CH₄, ethane, propane, or butane. In further preferred embodiments, the hydrocarbon is CH₄. In certain such embodiments, the CH₄ is a component of a gas mixture that also comprises other hydrocarbons, such as ethane, propane, or butane. For example, the gas mixture used to supply CH₄ may be (or may be derived from) flare gas, waste gas, natural gas, or the like.

In certain embodiments, the reduced carbon source gas is CO.

In some embodiments, the reduced carbon source gas is not methane.

In certain embodiments, the carbon source gas and the reduction gas are supplied at a ratio of from about 10:1 to about 1:10, from about 5:1 to about 1:5, from about 3:1 to about 1:3, from about 1:4 to about 4:1, from about 1:2 to about 2:1, from about 1.5:1 to about 1:1.5, from about 1.2:1 to about 1:1.2, or from about 1.1:1 to about 1:1.1.

In some embodiments, the product gas comprises less than about 10 mol % methane, less than about 5 mol % methane, less than about 2 mol % methane, less than about 1 mol % methane, less than about 0.5 mol % methane, less than about 0.2 mol % methane, less than about 0.1 mol % methane, less than about 0.05 mol % methane, less than about 0.02 mol % methane, or less than about 0.01 mol % methane.

In certain embodiments, the product gas comprises from about 0.0001 mol % methane to about 10 mol % methane, from about 0.0001 mol % methane to about 1 mol % methane, from about 0.0001 mol % methane to about 0.1 mol % methane, or from about 0.0001 mol % methane to about 0.01 mol % methane.

In certain preferred embodiments, the carbon source gas is CO₂, the reduction gas is H₂, and the reduced carbon source gas is CO.

In some embodiments, the pressure within the reactor unit is from about 0.5 bar to about 500 bar, from about 0.5 bar to about 300 bar, from about 0.5 bar to about 200 bar, from about 0.5 bar to about 100 bar, from about 0.5 bar to about 70 bar, from about 0.5 bar to about 50 bar, from about 0.5 bar to about 30 bar, from about 0.5 bar to about 20 bar, from about 0.5 bar to about 1.5 bar, from about 0.5 bar to about 10 bar, from about 0.5 bar to about 5 bar, from about 0.5 bar to about 3 bar, from about 0.5 bar to about 2 bar, from about 0.5 bar to about 1.5 bar, from about 0.8 bar to about 1.2 bar, or from about 0.9 bar to about 1.1 bar.

In some embodiments, at least about 50%, at least about 60%, at least about 70%, at least about 80%, at least about 90%, or at least about 95% of the surface of the catalytic member contacts the carbon source gas in the method.

In certain embodiments, from about 20% to about 99%, from about 30% to about 98%, from about 50% to about 95%, or from about 70% to about 90% of the surface of the catalytic member contacts the carbon source gas and the reduction gas in the method.

In certain embodiments, the method further comprises pulsing the heat of the catalytic member. As defined herein, “pulsing” refers to heating intervals where the catalytic member may be heated for a short period followed by no heat for another period, which is again followed by heat for a short period. In some embodiments, the pulsing the heat comprises an interval of about 0.01 to about 5 seconds of heat followed by an interval of about 0.01 to about 5 seconds of no heat followed by an interval of about 0.01 to about 5 seconds of heat. Pulsed operation may allow for the production of substances that are not stable at reaction temperatures.

In some embodiments, the catalytic member generates heat by at least one of resistive heating, inductive heating, dielectric heating, or frequency-based heating.

In certain embodiments, the catalytic member is electrically coupled to the pair of conductors by electrical resistance welding, brazing, chemical bonding, diffusion bonding, sintering, or mechanical contacts. In certain embodiments, a compatible material may be used to make a stable bond between the catalytic member and each of the conductors, such as the application of pastes comprising Si, C, Ni, B, N, Zn, Zr, Al, Au, W, Co, and Ta, or a combination thereof. In some embodiments, the pair of conductors is centered in the catalytic member. In certain preferred embodiments, the pair of conductors are located at opposite ends of the catalytic member. In certain embodiments, the contact surface area of each catalytic member-to-conductor bond may comprise between 1% and 50% of the geometric surface area of the catalytic member.

In some embodiments, the catalytic member has a length of from about 0.1 centimeters (cm) to about 2000 cm. In certain such embodiments, the catalytic member has a length from about 0.1 cm to about 1500 cm, about 0.1 cm to about 1000 cm, about 0.1 cm to about 500 cm, about 0.1 cm to about 250 cm, about 0.1 to about 100 cm, about 0.1 cm to about 50 cm, about 0.1 cm to about 40 cm, about 0.2 cm to about 30 cm, about 0.5 cm to about 20 cm, about 0.5 cm to about 10 cm, or about 1 cm to about 10 cm.

In certain embodiments, the catalytic member has an average ligament thickness of from about 0.005 micrometers (μm) to about 50 millimeters (mm), about 0.01 μm to about 40 mm, about 0.02 μm to about 20 mm, about 0.04 Lam to about 20 mm, about 0.05 μm to about 20 mm, about 0.05 μm to about 10 mm, about 0.1 μm to about 10 mm, about 0.2 μm to about 5 mm, about 0.4 μm to about 5 mm, about 0.5 μm to about 5 mm, about 0.5 μm to about 3 mm, about 0.5 μm to about 2 mm, about 1 μm to about 2 mm, about 1 μm to about 1 mm, about 10 μm to about 1 mm, or from about 10 μm to about 0.5 mm.

In certain embodiments, the catalytic member is heated to a temperature at least 10° C. greater, at least 20° C. greater, at least 50° C. greater, at least 100° C. greater, at least 200° C. greater, at least 500° C. greater, at least 750° C. greater, at least 1,000° C. greater, or at least 2,000° C. greater than an ambient temperature.

In some embodiments, the catalytic member is heated to a temperature of from 10° C. to 3,000° C., from 20° C. to 2,000° C., from 50° C. to 1,000° C., or from 200° C. to 700° C. greater than an ambient temperature.

In certain embodiments, the catalytic member has a specific surface area of at least about 1 square centimeter per gram (cm²g⁻¹), at least about 5 cm²g⁻¹, at least about 10 cm²g⁻¹, at least about 50 cm²g⁻¹, at least about 100 cm²g⁻¹, at least about 500 cm²g⁻¹, at least about 10³ cm² g⁻¹, at least about 5×10³ cm² g⁻¹, at least about 10⁴ cm² g⁻¹, at least about 5×10⁴ cm² g⁻¹, at least about 10⁵ cm² g⁻¹, at least about 5×10⁵ cm² g⁻¹, or at least about 10⁶ cm² g⁻¹.

In some embodiments, the catalytic member has a specific surface area of from about 1 square centimeter per gram (cm²g⁻¹) to about 10¹⁰ cm²g⁻¹, about 10 cm²g⁻¹ to 10¹ cm²g⁻¹ about 100 cm²g⁻¹ to 10⁸ cm²g⁻¹, about 10³ cm²g⁻¹ to 10⁸ cm²g⁻¹, about 10⁴ cm²g⁻¹ to 10⁸ cm²g⁻¹, about 10⁵ cm² g⁻¹ to 10⁸ cm² g⁻¹, or about 10⁵ cm² g⁻¹ to 10⁸ cm² g⁻¹.

In certain embodiments, the catalytic member has a porosity of at least about 60%, at least about 65%, at least about 70%, at least about 75%, at least about 80%, at least about 85%, at least about 90%, at least about 95%, at least about 96%, at least about 97%, at least about 98%, or at least about 99%.

In some embodiments, the catalytic member has a porosity of from about 60% to about 99%, from about 65% to about 98%, from about 70% to about 98%, from about 75% to about 98%, from about 80% to about 98%, or from about 85% to about 95%.

In certain embodiments, the catalytic member has a thermal conductivity of at least about 1 watts per meter Kelvin (Wm⁻¹K⁻¹), at least about 10 Wm⁻¹K⁻¹, at least about 20 Wm⁻¹K⁻¹, at least about 40 Wm⁻¹K⁻¹, at least about 50 Wm⁻¹K⁻¹, at least about 75 Wm⁻¹K⁻¹, at least about 90 Wm⁻¹K⁻¹ at least about 100 Wm⁻¹K⁻¹, at least about 125 Wm⁻¹K⁻¹, at least about 150 Wm⁻¹K⁻¹, or at least about 175 Wm⁻¹K⁻¹.

In certain embodiments, the catalytic member has a thermal conductivity of less than about 5 watts per meter Kelvin (Wm⁻¹K⁻¹), less than about 10 Wm⁻¹K⁻¹, less than about 20 Wm⁻¹K⁻¹, less than about 40 Wm⁻¹K⁻¹, less than about 50 Wm⁻¹K⁻¹, less than about 75 Wm⁻¹K⁻¹, less than about 90 Wm⁻¹K⁻¹ less than about 100 Wm⁻¹K⁻¹, less than about 125 Wm⁻¹K⁻¹, less than about 150 Wm⁻¹K⁻¹, or less than about 175 Wm⁻¹K⁻¹.

In some embodiments, the catalytic member has a thermal conductivity of from about 1 watts per meter Kelvin (Wm⁻¹K⁻¹) to about 200 Wm⁻¹K⁻¹, from about 20 Wm⁻¹K⁻¹ to about 150 Wm⁻¹K⁻¹, or from about 50 Wm⁻¹K⁻¹ to about 120 Wm⁻¹K⁻¹.

In certain embodiments, the catalytic member has an electrical conductivity of at least about 1 Siemens per meter (Sm⁻¹), at least about 20 Sm⁻¹, at least about 50 Sm⁻¹, at least about 100 Sm⁻¹, at least about 200 Sm⁻¹, at least about 500 Sm⁻¹, at least about 10³ Sm⁻¹, at least about 2×10³ Sm⁻¹, at least about 5×10³ Sm⁻¹, at least about 10⁴ Sm⁻¹, at least about 2×10⁴ Sm⁻¹, at least about 5×10⁴ Sm⁻¹, at least about 10⁵ Sm⁻¹, at least about 2×10⁵ Sm⁻¹, at least about 5×10⁵ Sm⁻¹, at least about 10⁶ Sm⁻¹, at least about 2×10⁶ Sm⁻¹, at least about 5×10⁶ Sm⁻¹, at least about 7×10⁶ Sm⁴, at least about 9×10⁶ Sm⁻¹ at least about 10×10⁶ Sm⁻¹, at least about 12×10⁶ Sm⁻¹, or at least about 14×10⁶ Sm⁻¹.

In certain embodiments, the catalytic member has an electrical conductivity of less than about 10 Siemens per meter (Sm⁻¹), less than about 20 Sm⁻¹, less than about 50 Sm⁻¹, less than about 100 Sm⁻¹, less than about 200 Sm⁻¹), less than about 500 Sm⁻¹, less than about 10³ Sm⁻¹, less than about 2×10³ Sm⁻¹, less than about 5×10³ Sm⁻¹, less than about 10⁴ Sm⁻¹, less than about 2×10 Sm⁻¹, less than about 5×10⁴ Sm⁻¹, less than about 10⁵ Sm⁻¹, less than about 2×10⁵ Sm⁻¹, less than about 5×10⁵ Sm⁻¹, less than about 10⁶ Sm⁻¹, less than about 2×10⁶ Sm⁻¹, less than about 5×10⁶ Sm⁻¹, less than about 7×10⁶ Sm⁻¹, less than about 9×10⁶ Sm⁻¹, less than about 10×10⁶ Sm⁻¹, less than about 12×10⁶ Sm⁻¹, or less than about 14×10⁶ Sm⁻¹) In some embodiments, the catalytic member has an electrical conductivity of from about 1 Siemens per meter (Sm⁻¹) to about 50 Sm⁻¹. In some embodiments, the catalytic member has an electrical conductivity of from about 10 Sm⁻¹ to about 10⁸ Sm⁻¹, from about 100 Sm⁻¹ to about 10⁸ Sm⁻¹, from about 10 Sm⁻¹ to about 10⁸ Sm⁻¹, or from about 10³ Sm⁻¹ to about 10⁷ Sm⁻¹.

In certain embodiments, the surface of the catalytic member reduces an activation energy of the chemical reaction by at least 10%, at least 20%, at least 30%, at least 40%, at least 50%, at least 60%, at least 70%, at least 80%, or at least 90%.

In some embodiments, the surface of the catalytic member reduces an activation energy of the chemical reaction by 10% to 90%, 20% to 80%, 30% to 70%, or 40% to 60%.

In certain embodiments, the catalytic member has an open-cell foam structure. In some embodiments, the catalytic member has a regular open-cell foam structure. According to one or more embodiments, the catalytic member has an irregular open-cell foam structure.

In certain embodiments, the catalytic member is a monolith composed of an array of parallel channels. The channels may be of any shape, such as rectangular, triangular, honeycomb-type structure, or any other cross-sectional shape. In certain embodiments, the channels may be interconnected via pores and/or additional channels. In other embodiments, the channels are not interconnected.

In certain embodiments, the catalytic member has a hierarchical structure. The hierarchical structure may be with respect to structure, pore size, composition, surface area, or active materials. In some embodiments, the hierarchical structure has at least two levels of pore sizes: large pores which act as mass transport “highways” that allow the reactants to diffuse to small pores and/or nanosized pores. In certain embodiments, the hierarchical structure comprises hierarchical layers of distinct phases or compositions (e.g., an underlying metallic substrate, and oxide layer, and deposited active metal species). In certain embodiments, each of the hierarchical layers comprises pores and ligaments progressively decreasing in size. In certain embodiments, the underlying metallic substrate has a high surface area, three-dimensional, porous structure of much smaller characteristic lengths. In some embodiments, the oxide layer is formed through the oxidization of alloys to promote a strong adherence of the coating. In certain embodiments, the oxide layer is a mixed metal oxide layer comprising a at least two metallic elements and oxygen. In some embodiments, there is a conductive core structure, a protective ceramic layer conformally deposited on top of the core, an outer catalytically active layer composed of metal oxide(s) and/or active catalytic phases. In certain embodiments, the metal oxide(s) is(are) the active catalytic phase. In some embodiments, the oxide layer promotes a strong adherence of a metal oxide coating.

In certain embodiments, a cross-sectional area of the largest pore of the catalytic member is greater than a cross-sectional area of the smallest pore of the catalytic member by a factor of less than about 100, less than about 50, less than about 20, less than about 15, less than about 10, less than about 7, less than about 5, less than about 3, less than about 2, less than about 1.5, less than about 1.2, or less than about 1.1. In some embodiments, a cross-sectional area of the largest pore of the catalytic member is greater than a cross-sectional area of the smallest pore of the catalytic member by a factor at least about 1.2, at least about 1.5, at least about 2, at least about 5, at least about 10, at least about 20, at least about 50, at least about 100, at least about 500, or at least about 1,000.

In some embodiments, a cross-sectional area of the largest pore of the catalytic member is greater than a cross-sectional area of the smallest pore of the catalytic member by a factor of from about 1.05 to about 10,000, from about 1.05 to about 1,000, from about 1.05 to about 500, from about 1.05 to about 100, from about 1.05 to about 50, from about 1.05 to about 10, from about 1.05 to about 5, from about 1.05 to about 3, or from about 1.05 to about 1.2.

In some embodiments, the catalytic member comprises a metal selected from Ni, Al, Cu, Au, Ag, Mo, Mn, V, Fe, Co, Cr, Pt, Pd, C, In, Ta, Ti, W, Sn, In, Zn, or a combination thereof. In some embodiments, the catalytic member comprises a metal selected from Ni, Al, Cu, Au, Ag, Mo, Mn, V, Fe, Co, Cr, Pt, Pd, La, Ce, Ba, C, In, Ta, Ti, W, Ru, Rh, Ir, Sn, In, and Zn, or a combination thereof. In certain preferred embodiments, the catalytic member comprises Ni. In some preferred embodiments, the catalytic member consists essentially of a metal selected from Ni, Al, Cu, Au, Ag, Mo, Mn, V, Fe, Co, Cr, Pt, Pd, C, In, Ta, Ti, W, Sn, In, Zn, or a combination thereof. In some preferred embodiments, the catalytic member consists essentially of a conductive metal selected from Ni, Al, Cu, Au, Ag, Mo, Mn, V, Fe, Co, Cr, Pt, Pd, La, Ce, Ba, C, In, Ta, Ti, W, Ru, Ir, Rh, Sn, In, Zn, or a combination thereof. In certain preferred embodiments, the catalytic member consists essentially of Ni.

In certain embodiments, the catalytic member comprises a ceramic. As will be appreciated by one of skill in the art, any suitable ceramic with a suitable resistivity may be used in the systems and methods provided herein. The particular embodiments set forth below are provided both to exemplify such ceramics and to identify ceramics particularly well-suited for use in conjunction with the other features of the systems and methods disclosed herein. In some preferred embodiments, the ceramic is SiC. In certain embodiments, the catalytic member comprises an electrically conductive bulk that consists essentially of a conductive ceramic, and further comprises a catalytic surface, e.g., a suitable catalytic coating as exemplified herein. In certain embodiments, the catalytic member consists essentially of SiC. In certain embodiments, the ceramic comprises a dopant. In certain preferred embodiments, the dopant modifies the resistivity of the ceramic. In certain embodiments, the dopant is selected from C, Ni, W, B, Si, Mo, V, Ta, Ti, Co, Zr, and N, or a combination thereof. In certain preferred embodiments, the ceramic is SiC and the dopant comprises free carbon or silicon, MoSi₂, and/or controlled amounts of beta-SiC in combination with alpha-SiC.

In certain embodiments, the conductive ceramic comprises an active metal catalyst disposed directly on the conductive ceramic. In some such embodiments, the active metal catalyst is a layer disposed on the surface of the conductive ceramic. In certain embodiments, the active metal catalyst is disposed on the surface of the conductive ceramic in the form of particles. In other embodiments, the catalytic member comprises one or more layers of a metal oxide (or a mixed metal oxide)disposed on the outer surface of the ceramic, and the catalytic member further comprises an active metal catalyst layer disposed on the outermost surface of the metal oxide or mixed metal oxide layer(s).

In certain embodiments, the catalytic member comprises a ceramic-metallic composite (e.g., a CerMet material) comprising a ceramic component and a metallic component. In some such embodiments, the ceramic component of the ceramic-metallic composite is a conductive ceramic as described herein, and the metallic component of the ceramic-metallic composite is a conductive metal as described herein. In preferred embodiments, the ceramic-metallic composite comprises an active metal catalyst disposed directly on the ceramic-metallic composite. In some such embodiments, the active metal catalyst is a layer disposed on the surface of the ceramic-metallic composite. In certain embodiments, the active metal catalyst is disposed on the surface of the ceramic-metallic composite in the form of particles. In other embodiments, the catalytic member comprises one or more layers of a metal oxide (or a mixed metal oxide) disposed on the outer surface of the ceramic-metallic composite, and the catalytic member further comprises an active metal catalyst layer disposed on the outermost surface of the metal oxide or mixed metal oxide layer(s).

In certain embodiments, the catalytic member has a macrostructure in the shape of a cylinder, rectangular prism, sphere, annular sphere, helix, or a combination thereof. In certain preferred embodiments, the catalytic member has a macrostructure in the shape of a helix. In some embodiments, the macroscopic shape of the catalytic member is designed to maximize heat transfer and interaction with the carbon source gas and the reduction gas.

The catalytic members described herein may be fabricated using any suitable technique.

In some embodiments, for catalytic members comprising a ceramic (preferably wherein the ceramic is a carbide or doped carbide-based material) with a 3-dimensional open cell structure, the 3-dimensional open cell structure may be derived from a polymer template.

In certain embodiments, a precursor resin (e.g. phenolic resin) is used to impregnate a polyurethane open-cell foam, thereby forming an impregnated polyurethane open-cell foam. The impregnated polyurethane open-cell foam is pyrolyzed in an inert atmosphere to generate a reticulated vitreous carbon. In certain such embodiments, ceramic precursors (e.g., Si, Zr, and/or Ti) can then be deposited, e.g., by Chemical Vapor Deposition (CVD) to yield a carbide-based ceramic material. In other embodiments, the polyurethane foam is used as a template to host a pre-ceramic slurry (e.g., SiC, binders, phenolic resin, wax, or other graphite precursors) via a slip-casting process, thereby forming a coated foam. In certain such embodiments, the coated foams are pyrolyzed and further reacted with free metal or metalloid precursors (e.g., molten silicon) to convert the coated foam into a carbide ceramic. In some such embodiments, excess metal or metalloid is used or added to impart control over the resistivity of the component.

In certain embodiments, a polymer or other mold may be prepared, e.g., by 3D printing, into which a pre-ceramic slurry comprising ceramic particles, binder, and wax is deposited and allowed to cure. In some such embodiments, the mold is then removed by dissolution, oxidation, decomposition, or other suitable methods. In further such embodiments, the resulting 3-dimensional pre-ceramic is sintered and/or doped to form a rigid, conductive ceramic.

In some embodiments, the ceramic material may be further treated. In certain such embodiments, the ceramic material is further treated by oxidation in an oxidation gas selected from air, oxygen, ozone, a combination thereof, or another suitable oxidizing environment, including e.g., chemical oxidation in solution. This further treatment makes the surface more hydrophilic and provides improved adhesion of oxide-based catalytic materials that may be applied to the surface by, e.g., wash-coating.

In certain embodiments, the ceramic element is 3D-printed from a pre-ceramic polymer resin or using binderjet printing in which the ceramic is deposited with the use of a binder prior to sintering at high temperature. In alternative embodiments, a ceramic slurry may be deposited using an extrusion process.

In some embodiments, the catalytic member is formed by plating of a polymer template, casting, 3D printing, or foaming of melted (i.e., molten) metal. In certain embodiments, the catalytic member is further processed by free corrosion, electrochemical dealloying, or oxidation.

In certain embodiments, the catalytic member comprises one or more metals, one or more alloys, one or more ceramics, or a combination thereof. In some embodiments, the catalytic member comprises a support material and a catalytic material.

In further embodiments, the catalytic member further comprises a ceramic. In yet further embodiments, the ceramic is or comprises SiC.

In certain embodiments, the support material comprises an oxide or carbide of a metal selected from Al, Cr, Fe, Co, Na, K, Mg, Ca, Mn, Mo, V, Sn, Si, La, Pr, Ce, and Zn, or a combination thereof. In certain embodiments, the support material comprises an oxide or carbide of a metal selected from Al, Cr, Fe, Co, Na, K, Mg, Ca, Mn, Mo, V, Sn, Si, La, Pr, Ce, Zn, Ti, Zr, and Ba, or a combination thereof. In some embodiments, the catalytic material comprises a metal selected from Ni, Al, Cu, Au, Ag, Mo, Mn, V, Fe, Co, Cr, Pt, Pd, C, In, Ta, Ti, W, Sn, In, and Zn, or a combination thereof. In some embodiments, the catalytic material comprises a metal selected from Ni, Al, Cu, Au, Ag, Mo, Mn, V, Fe, Co, Cr, Pt, Pd, C, In, Ta, Ti, W, Ru, Rh, Ir, Sn, In, and Zn, or a combination thereof.

In further embodiments, the catalytic material comprises an alloy. In yet further embodiments, the alloy is selected from hastelloy, incoloy, inconel, or monel. In still further embodiments, the alloy is or comprises hastelloy.

In certain embodiments, the catalytic material is deposited on the surface of the support material. In some embodiments, the catalytic material is deposited on the support material by dip coating, corrosion, electroplating, electrostatic adsorption, electrooxidation, electroreduction, galvanic exchange, wetness impregnation, or deposition precipitation. In certain embodiments, the catalytic material is substantially intermixed with the support material.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art. The methods and techniques of the present disclosure are generally performed, unless otherwise indicated, according to conventional methods well known in the art and as described in various general and more specific references that are cited and discussed throughout this specification. Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

In some embodiments, the numbers used to describe and claim certain embodiments of the disclosure are modified in some instances by the term “about.” In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In certain embodiments, the term “about” means within 10%, 9%, 8%, 7%, 6%, 5%, 4%, 3%, 2, 1%, 0.5%, or 0.05% of a given value or range.

### EXAMPLES

The invention now being generally described, it will be more readily understood by reference to the following examples which are included merely for purposes of illustration of certain aspects and embodiments of the present invention, and are not intended to limit the invention.

### Fabrication of Catalytic Members

### Example 1: General Procedure for Electroless and Electro-Plating of Polymer Template

An open-cell porous polymer structure template is prepared by foaming a polymer melt. The polymer template is treated to activate the surface for metal deposition. A metal is deposited on the template via electroless deposition to a thickness of about 1 micrometer. The polymer template is then removed by decomposition at high temperature.

### Example 2: First General Procedure for Casting

A wax based model is used to fabricate a mold from plaster. The wax is removed from the mold by melting. A melt of a metal composition is then poured into the mold to create a 3-dimensional structure. The melt contains metal oxide powders to stabilize the structure and provide catalytically active additives and support materials. The polymer is then removed.

### Example 3: Second General Procedure for Casting

An open-cell polymer foam is used to fabricate a mold by filling the pores with a slurry of a heat resistant material. A melt of a metal composition is then poured into the investment mold to create a 3-dimensional structure. The polymer is then removed.

### Example 4: First General Procedure for Casting Composite Materials

Spheres, granules, and other particulates composed of metal oxides, carbides, salts, and polymers are packed inside a larger mold. Molten metal is then poured into the interstitial spacing. Vacuum is used to fill the interstitial space entirely. Polymers and metal oxides are then removed by thermal treatment. The final composition of the melt includes some of the metal oxide components to promote structural integrity and catalytic activity.

### Example 5: Second General Procedure for Casting Composite Materials

Spheres, granules, and other particulates are pressed into a mold with a powdered metal precursor. A binder is used to adhere the metal powder to the spheres, granules, and particulates. Heat is applied, which causes sintering of the metal powder, resulting in a porous foam structure. The space filling spheres, granules, and particulates is then be removed by thermal treatment.

### Example 6: First General Procedure for Foaming of Metal Melt

A gas is injected through a metal melt to foam the metal melt and afford an open cell porous structure.

### Example 7: Second General Procedure for Foaming of Metal Melt

A blowing agent is added to a metal melt, where the blowing agent decomposes above the melting temperature of the parent melt, releasing a gas that aids in the formation of pores of the resulting open cell porous structure.

### Example 8: Third General Procedure for Foaming of Metal Melt

Hydrogen is dissolved into a metal melt at high pressure. The pressure is then lowered and the melt is cooled to afford an open cell porous structure.

### Example 9: Fourth General Procedure for Foaming of Metal Melt

Metal powder precursor is intermixed with a blowing agent and compacted. The material is then formed into the desired shape and treated with heat to afford an open cell porous structure.

### Example 10: First General Procedure for Direct 3D Printing

A metal is extruded directly into an open cell porous structure.

### Example 11: Second General Procedure for Direct 3D Printing

A metal precursor is shaped into an open cell porous structure by selective laser melting in a printing bed.

### Example 12: First General Procedure for Additional Processing

An open cell porous structure (e.g., formed from one of the processes described in Examples 1-11) is wash-coated by dipping the structure in a slurry of a metal oxide.

### Example 13: Second General Procedure for Additional Processing

An open cell porous structure (e.g., formed from one of the processes described in Examples 1-11) is thermally sprayed with a metal to deposit a low contact resistance coating.

### Example 14: Procedures for Preparing Exemplary Ni Foam-Based Catalytic Members

Alumina-coated Ni foams—For alumina-coated Ni foams, a 10 wt % aluminum-based gel (aluminum phosphate) was used to wash coat a 60 mm×6 mm×1.6 mm Ni foam. The nickel foam was cleaned using acetone and isopropanol and dried. The foam was dipped into the alumina gel and allowed to set for 1 h in air. The coated substrate was calcined in in air at 93.3 C for 2 h, 260 C for 2 h, and 371.1 C for 2 h.

Pt CeO₂-coated Ni foams—Cerium oxide (CeO₂) was coated onto the Ni foam as follows: 1 g of CeO₂ was added to 12 mL of concentrated HCl and this solution was heated to 80° C. and held until all of the liquid evaporated. To this solid, 15 mL of D.I. water was added, which yields a highly dispersed colloidal solution. The nickel foam was dip coated, dried and calcined at 450° C. for 4 h at 5° C./min ramp rate. The dip coating process was repeated to achieve a total loading of 5-10 wt % CeO2. Platinum was deposited by tip-coating from a 0.2% aqueous solution of platinum tetraaine nitrate.

### Example 15: Procedures for Preparing Exemplary Ceramic-Based Catalytic Members

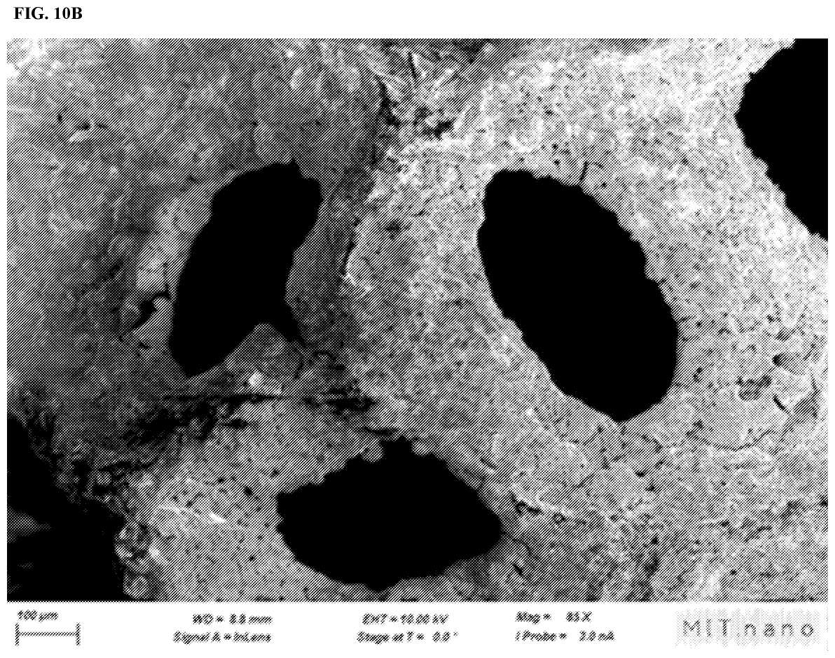

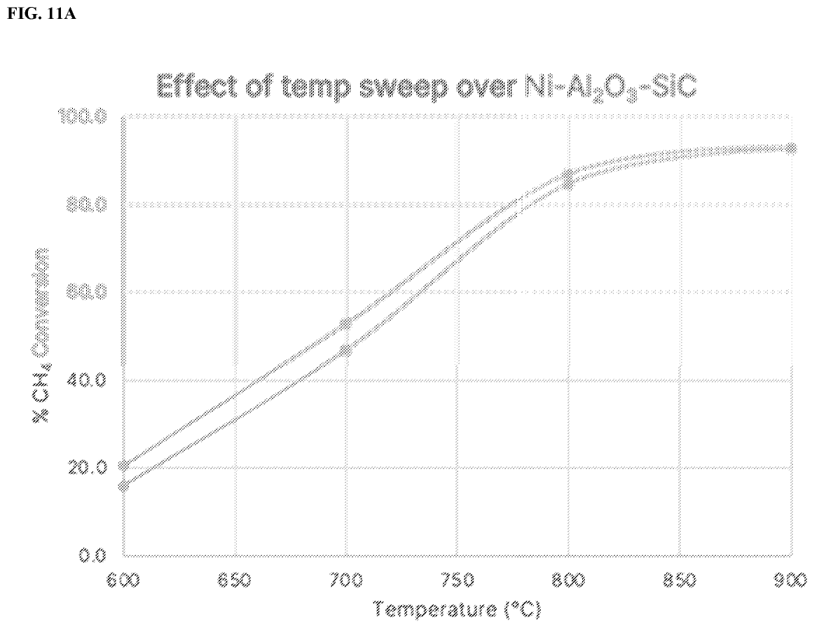

SiC foam cylinders (purchased from Ultramet) were cleaned by submerging and sonicating in acetone for 15 minutes, rinsing with acetone 3 times, drying at 65° C. for 1 hour and repeating with isopropanol. The cylinders were then dipped in a slurry containing an Al₂O₃-based support material and an AlOOH binder. The cylinder was removed from the slurry and spun (typically axially) at 3000 rpm for 45 s. The resulting material was calcined by ramping from ambient temperature to 550° C. at a rate of 220° C./h, and holding at 550° C. for 1 hour. The resulting element assembly was dipped in a 0.667 M aqueous solution of Ni(NO₃)₂. and then spun at 2000 rpm for 60 s. The coated element was dried at 350 degrees Celsius for 1 hour. As will be appreciated by one of skill in the art, this procedure may be modified for use with other suitable binders, support materials, or metal precursors. SEM images of exemplary Ni/Al₂O₃-coated SiC foams are given in FIGS. 10A and 10B.

### Assembly and Use of Exemplary Reactor Unit for a Reverse Water-Gas Shift Reaction

### Example 16: Procedures for Assembling, Activating, and Using Exemplary Reactors

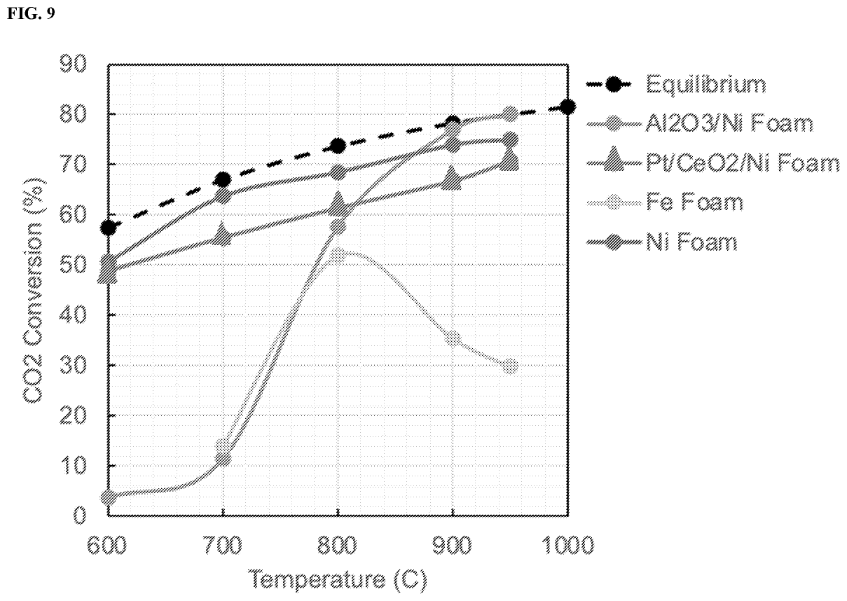

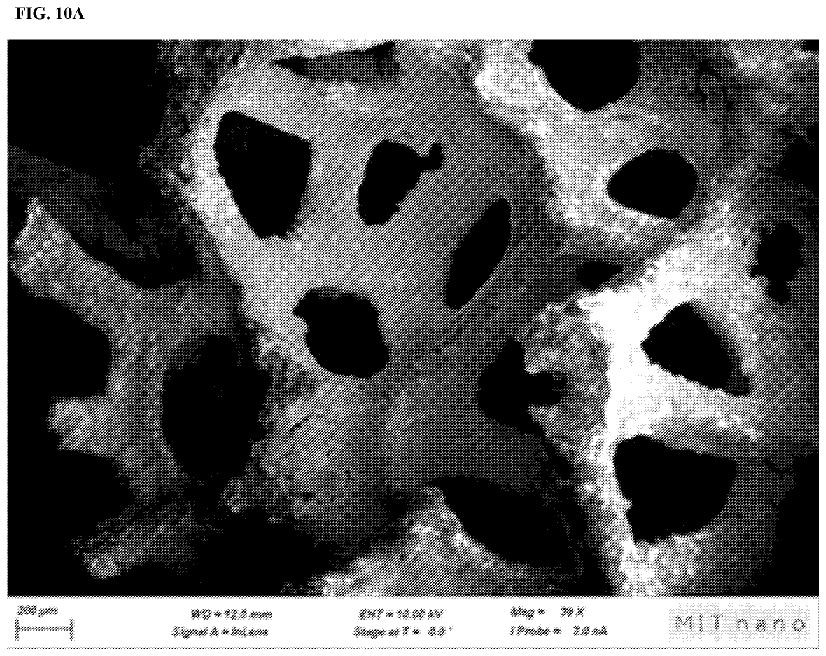

A catalytic member of the disclosure (e.g., bare nickel foam, bare iron foam, alumina-coated nickel foam, and Pt/CeO₂ coated nickel foam) were attached to stainless steel electrode rods, using a set screw tapped into the electrode tips. The surface of the catalytic member was activated by reducing in flowing H₂ at 650° C. for 30 minutes prior to reaction. Hydrogen and carbon dioxide were fed to the reactor system in a 3:1 ratio at a flow rate of 80-120 mL/min. Power was supplied from a DC power supply to the electrodes, thereby heating the sample. Temperature was measured using a pyrometer placed outside of the quartz tube. Outlet gas concentration was measured using an online gas chromatograph (FIG. 9).

### Example 17: Assembly of Exemplary Reactor Unit

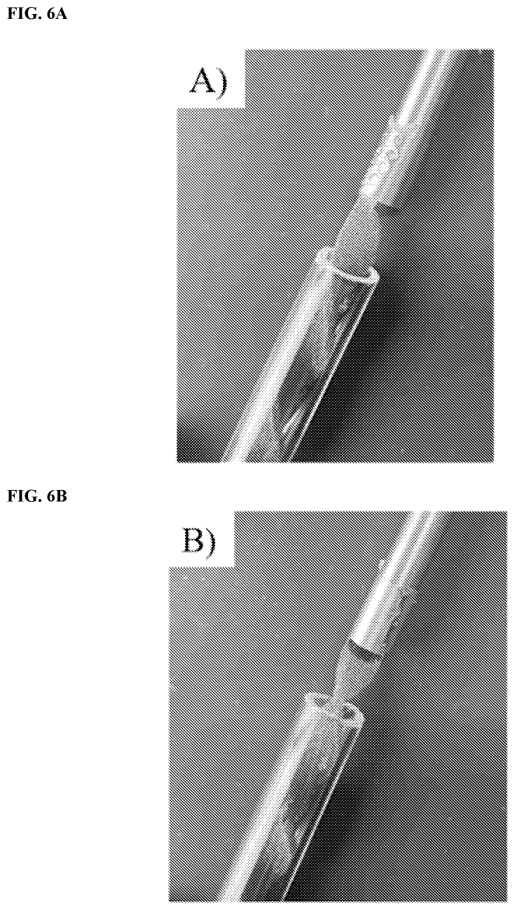

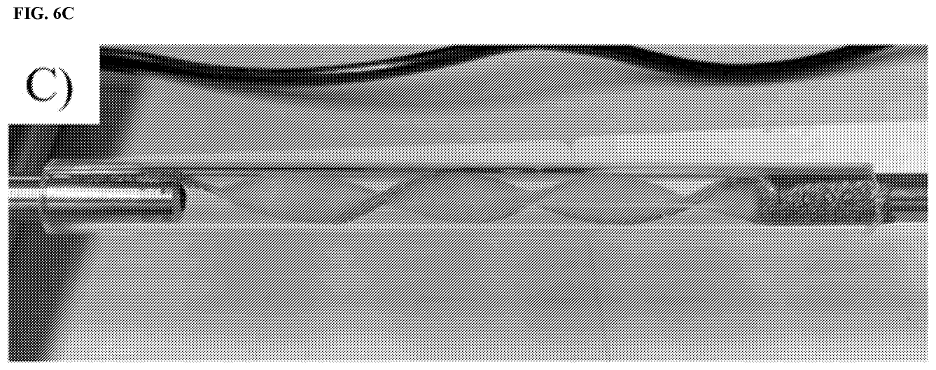

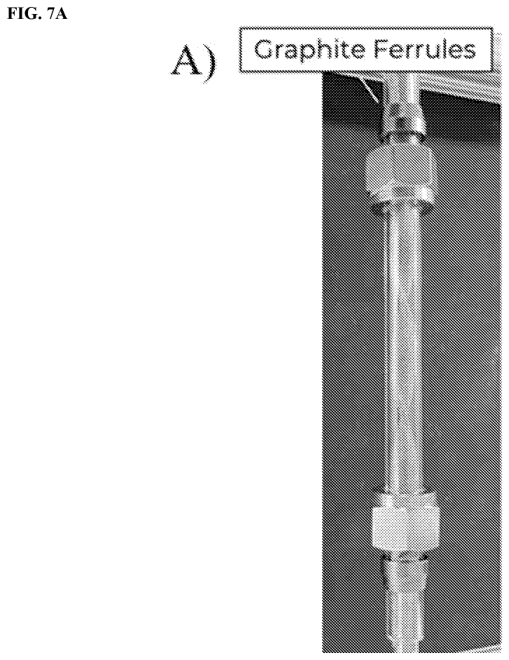

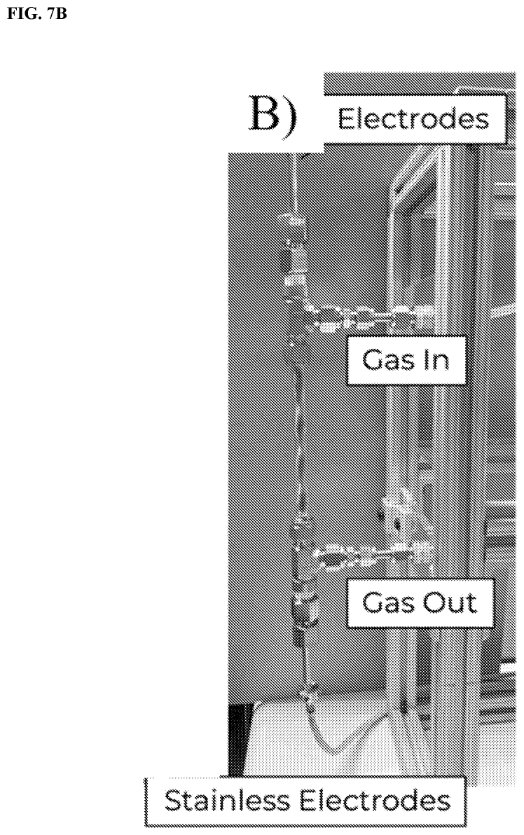

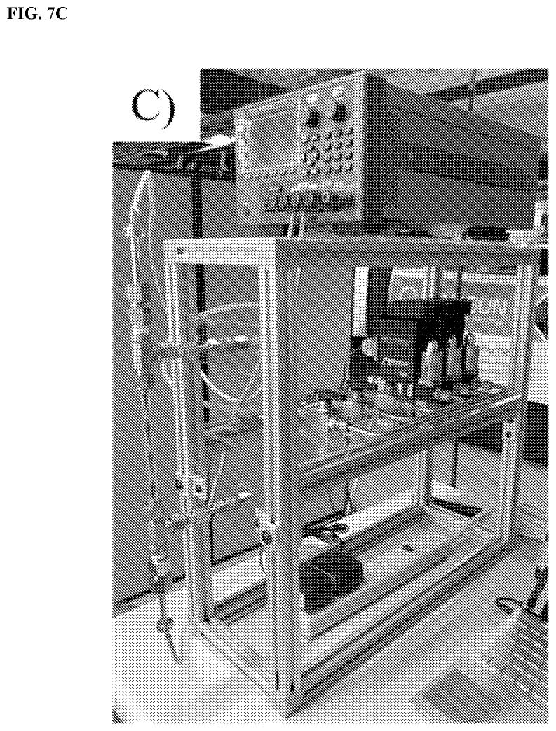

A strip of nickel foam (4 mm×80 mm) was cut from a commercially available material, twisted into a helical shape with care to not damage the ligament structure, and spot welded to two stainless steel electrode rods. The ends of the strip were compressed prior to spot welding to reduce the local resistance, ensuring proper adhesion without damaging the porous structure. This assembly was inserted into a quartz tube with an inner diameter equivalent to the outer diameter of the nickel foam static mixer (see FIGS. 6A-6C). Stainless steel fittings with dielectric ferrules/sheathes were used to isolate the electrodes from the rest of the system while allowing gas to flow through the exemplary reactor unit. The electrodes were electrically coupled to a DC power supply and the reactor unit was fitted with adaptors to receive and output a gas (see FIGS. 7A-7C).

### Example 18: Use of Exemplary Reactor Unit for a Reverse Water Gas Shift Reaction

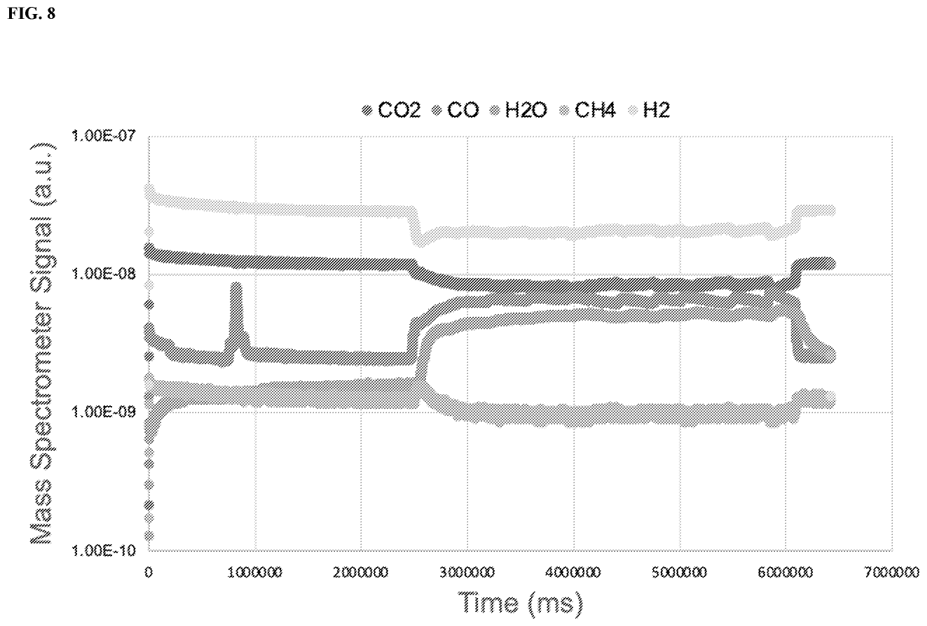

A reaction gas comprising 3% CO₂, 3% H₂, and 94% He was introduced into the exemplary reactor unit at 50 mL per minute at atmospheric pressure. The gas phase was monitored at the outlet of the reactor unit by a residual gas analyzer (see FIG. 8). The power was increased in increments of 0.5A (current control) until reaction was observed (˜13A/˜8V). This amount of power was necessary to heat the nickel foam to sufficiently high temperature for reaction (600° C.) but does not reflect a balanced energy supply for the amount of gas flowing through the reactor, which was limited by the mass flow controllers. Conversion of CO₂ to CO via the reverse water gas shift reaction was observed according to the thermodynamic equilibrium conversion:

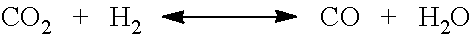

No methanation was observed, indicating a 100% selectivity from CO₂ to CO.

### Example 19: Assembly and Use of Exemplary Reactor Unit for Methane Reforming

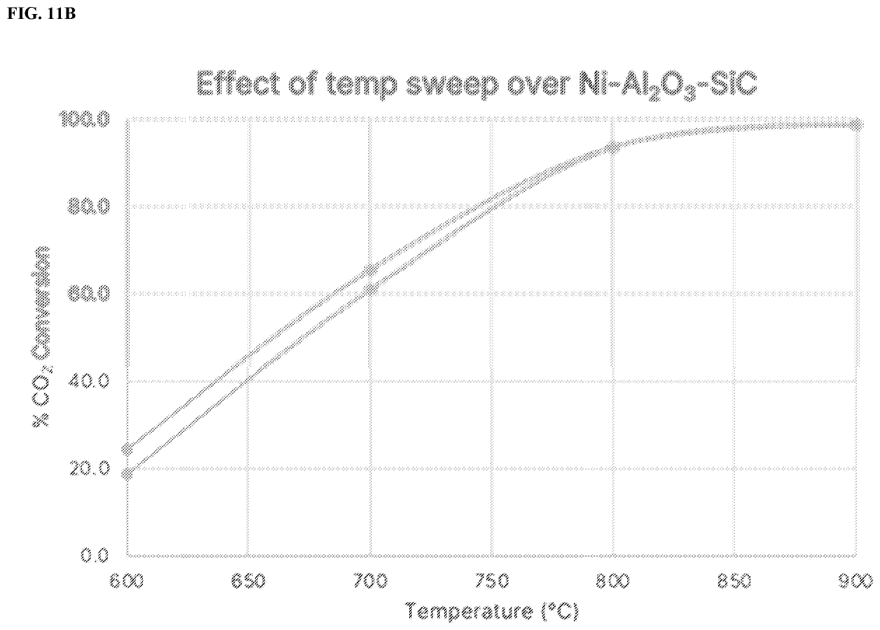

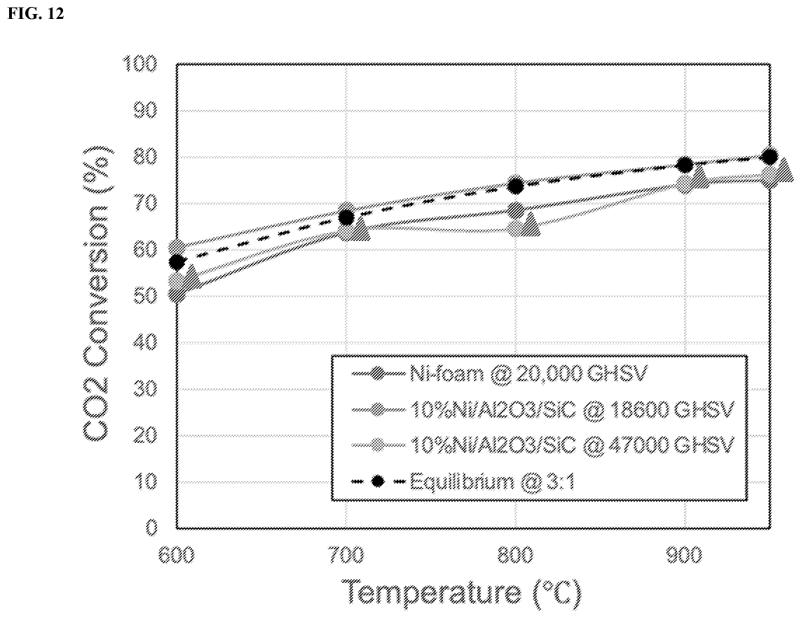

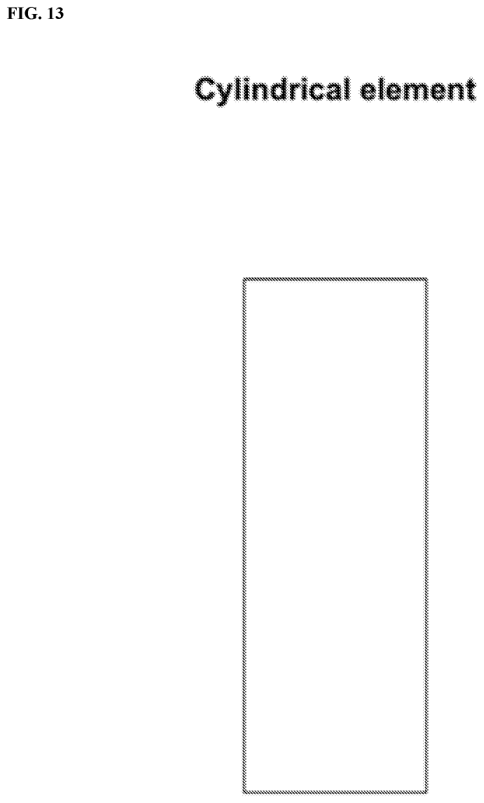

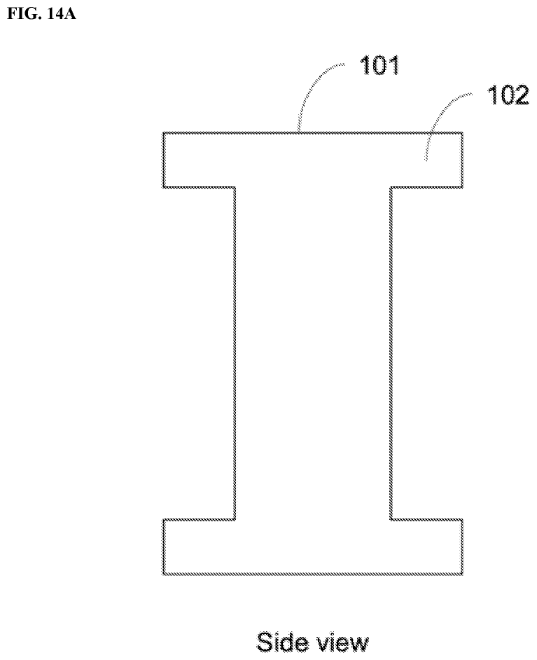

A Ni/Al₂O₃-coated SiC catalytic member was loaded into a quartz tube. The quartz tube was sealed on either end against a stainless steel flange with a gasket. Electrical contact between the coated catalytic element and the stainless steel flange was made with the use of a carbon cement and stainless steel washers. The flanges were modified with fittings on either end to allow for the passage of gas through the quartz tube. A feed gas comprising 500 sccm of CO₂ and 500 sccm of CH₄ was passed through the reactor assembly. Temperature was controlled by the passage of current through the element with the use of a Keysight power supply. A pyrometer was used to measure the temperature of the element (using a wavelength transparent to quartz). A PID controller was implemented to control the temperature of the reactor system. Outlet gas concentration was measured using an online gas chromatograph (FIGS. 11A and 11B).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A reactor unit comprising: an insulating housing; an inlet configured to receive a reaction fluid; an outlet configured to output a product fluid; and a catalytic member; wherein: the catalytic member is thermally conductive and electrically conductive; and the catalytic member is fixed in the reactor unit and electrically coupled to a pair of conductors configured to apply electrical power to the catalytic member.

2. (canceled)

3. (canceled)

4. (canceled)

5. (canceled)

6. (canceled)

7. The reactor unit of claim 1, wherein the catalytic member has a length of from about 0.1 centimeters (cm) to about 2000 cm, and preferably from about 0.1 to about 40 cm.

8. The reactor unit of claim 1, wherein the catalytic member has a specific surface area of at least about 1 square centimeter per gram (cm²g⁻¹).

9. The reactor unit of claim 1, wherein the catalytic member has a porosity of at least about 65%.

10. The reactor unit of claim 1, wherein the catalytic member has a thermal conductivity of at least about 1 Watt per meter Kelvin (Wm⁻¹K⁻¹).

11. The reactor unit of claim 1, wherein the catalytic member has an electrical conductivity of less than about 50 Siemens per meter (Sm⁻¹).

12. The reactor unit of claim 1, wherein the catalytic member has an open-cell foam structure.

13. The reactor unit of claim 12, wherein the catalytic member has an average ligament thickness of from about 0.1 micrometers (μm) to about 10 millimeters (mm).

14. (canceled)

15. (canceled)

16. The reactor unit of claim 12, wherein a cross-sectional area of the largest pore of the catalytic member is greater than a cross-sectional area of the smallest pore of the catalytic member by a factor of less than about 20.

17. The reactor unit of claim 16, wherein the cross-sectional area of the largest pore of the catalytic member is greater than the cross-sectional area of the smallest pore of the catalytic member by a factor of at least about 10.

18. (canceled)

19. The reactor unit of claim 1, wherein the catalytic member comprises:
one or more metals selected from Ni, Al, Cu, Au, Ag, Fe, Co, Cr, Pt, Pd, C, In, Ta, Ti, W, Ru, Rh, Ir, Sn, In, Hf, Nd, Y and Zn, or a combination thereof,
one or more alloys selected from hastelloy, incoloy, inconel, monel, or a combination thereof,
one or more ceramics, or
a combination thereof.

20. (canceled)

21. (canceled)

22. (canceled)

23. The reactor unit of claim 19, wherein the ceramic is or comprises SiC.

24. (canceled)

25. The reactor unit of claim 1, wherein the catalytic member has a macrostructure in the shape of a cylinder, rectangular prism, sphere, annular cylinder, or helix.

26. (canceled)

27. (canceled)

28. (canceled)

29. The reactor unit of claim 1, wherein the catalytic member comprises a support material and a catalytic material.

30. (canceled)

31. (canceled)

32. The reactor unit of claim 29, wherein the support material comprises an oxide or carbide of a metal chosen from Al, Cr, Fe, Co, Na, K, Mg, Ca, Mn, Mo, V, Sn, Si, La, Pr, Ce, Zn, Ti, Zr, and Ba, or a combination thereof.

33. The reactor unit of claim 29, wherein the catalytic material comprises a metal chosen from Ni, Al, Cu, Au, Ag, Mo, Mn, V, Fe, Co, Cr, Pt, Pd, La, Ce, Ba, C, In, Ta, Ti, W, Ru, Rh, Ir, Sn, In, Hf, Nd, Y and Zn, or a combination thereof.

34. (canceled)

35. (canceled)

36. (canceled)

37. A reactor assembly comprising a plurality of the reactor units of claim 1, wherein the catalytic member of each reactor unit is electrically isolated from catalytic members of adjacent reactor units.

38. The reactor assembly of claim 37, wherein the housings of the reactor units of the reactor assembly are in the shape of a cylinder, a cone, or a rectangular prism.

39. (canceled)

40. (canceled)

41. (canceled)

42. (canceled)

43. (canceled)

44. (canceled)

45. (canceled)

46. (canceled)

47. The reactor assembly of claim 37, wherein each of the reactor units are separated from adjacent reactor units via a spacer comprising an insulating material.

48. The reactor assembly of claim 47, wherein the insulating material is ceramic, glass, rubber, or plastic.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)
